(19) United States
(12) Patent Application Publication
(10) Pub. No.: US 2026/0268563 A1
(43) Pub. Date: Sep. 10, 2026

(54) ANIMATION GENERATION METHOD AND APPARATUS, COMPUTER DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventors: Yuzhou HUANG, Shenzhen (CN); Xintao WANG, Shenzhen (CN); Ying SHAN, Shenzhen (CN)

(73) Assignee: TENCENT TECHNOLOGY (SHENZHEN) COMPANY LIMITED, Shenzhen (CN)

(21) Appl. No.: 19/670,657

(22) Filed: May 7, 2026

Related U.S. Application Data
(63) Continuation of application No. PCT/CN2025/084666, filed on Mar. 25, 2025.

(30) Foreign Application Priority Data
Apr. 26, 2024 (CN) 202410540501.2

(51) Int. Cl. G06T 13/00

(52) U.S. Cl. CPC G06T 13/00; G06T 2213/04

(57) ABSTRACT

An animation generation method includes obtaining a first description text describing an animation, determining a first function library from a plurality of function libraries based on the first description text, each of the plurality of function libraries comprising functions for generating animations, determining a first function in the first function library based on the first description text, generating animation generation code corresponding to the first description text based on the first function, and executing the animation generation code corresponding to the first description text to obtain a first animation, content of the first animation conforming to content described by the first description text.

### CROSS-REFERENCE TO RELATED APPLICATIONS

This application is a continuation application of International Application No. PCT/CN2025/084666 filed on Mar. 25, 2025, which claims priority to Chinese Patent Application No. 202410540501.2 filed with the China National Intellectual Property Administration on Apr. 26, 2024, the disclosures of each being incorporated by reference herein in their entireties.

### FIELD

The disclosure relates to the field of computer technologies, and in particular, to an animation generation method and apparatus, a computer device, a storage medium, and a program product.

### BACKGROUND

With the rapid development of computer technologies, video games, films, and the like have attracted more attention. Therefore, animation production has also become one of important technologies in the related field.

In the related art, an animation engineer usually needs to design a scene, a role, a role action, and the like in an animation by using animation production software, and render manually configured animation resources to obtain the animation, which consumes a large amount of manpower and time, resulting in low animation generation efficiency.

### SUMMARY

Some embodiments provide an animation generation method and apparatus, a computer device, a storage medium, and a program product, to improve animation generation efficiency.

One or more embodiments provide an animation generation method including: obtaining a first description text describing an animation; determining a first function library from a plurality of function libraries based on the first description text, each of the plurality of function libraries comprising functions for generating animations; determining a first function in the first function library based on the first description text; generating animation generation code corresponding to the first description text based on the first function; and executing the animation generation code corresponding to the first description text to obtain a first animation, content of the first animation conforming to content described by the first description text.

One or more embodiments provide an animation generation apparatus including: at least one memory configured to store program code; and at least one processor configured to read the program code and operate as instructed by the program code, the program code comprising: text obtaining code configured to cause at least one of the at least one processor to obtain a first description text for describing an animation; function library determining code configured to cause at least one of the at least one processor to determine a first function library from a plurality of function libraries based on the first description text, each of the plurality of function libraries comprising functions for generating animations; function determining code configured to cause at least one of the at least one processor to determine a first function in the first function library based on the first description text; code generation code configured to cause at least one of the at least one processor to generate animation generation code corresponding to the first description text based on the first function; and animation generation code configured to cause at least one of the at least one processor to execute the animation generation code corresponding to the first description text to obtain a first animation, content of the first animation conforming to content described by the first description text.

One or more embodiments provide a non-transitory computer-readable storage medium, storing computer code which, when executed by at least one processor, causes the at least one processor to at least: obtain a first description text describing an animation; determine a first function library from a plurality of function libraries based on the first description text, each of the plurality of function libraries comprising functions for generating animations; determine a first function in the first function library based on the first description text; generate animation generation code corresponding to the first description text based on the first function; and execute the animation generation code corresponding to the first description text to obtain a first animation, content of the first animation conforming to content described by the first description text.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment according to one or more embodiments.

FIG. 2 is a flowchart of an animation generation method according to one or more embodiments.

FIG. 3 is a flowchart of another animation generation method according to one or more embodiments.

FIG. 4 is a schematic diagram of an animation generation method according to one or more embodiments.

FIG. 5 is a flowchart of another animation generation method according to one or more embodiments.

FIG. 6 is a schematic diagram of another animation generation method according to one or more embodiments.

FIG. 7 is a schematic result diagram of an animation generation method according to one or more embodiments.

FIG. 8 is a flowchart of another animation generation method according to one or more embodiments.

FIG. 9 is a schematic diagram of another animation generation method according to one or more embodiments.

FIG. 10 is a flowchart of another animation generation method according to one or more embodiments.

FIG. 11 is a schematic structural diagram of an animation generation apparatus according to one or more embodiments.

FIG. 12 is a schematic structural diagram of another animation generation apparatus according to one or more embodiments.

FIG. 13 is a schematic structural diagram of a terminal according to one or more embodiments.

FIG. 14 is a schematic structural diagram of a server according to one or more embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

The terms “first”, “second”, and the like used herein may be used for describing various concepts in this specification. However, the concepts are not limited by the terms unless otherwise specified. The terms are used only to distinguish a concept from another concept. For example, without departing from the scope of the disclosure, a first animation may be referred to as a second animation, and similarly, the second animation may be referred to as the first animation.

The term “at least one” refers to one or more. For example, at least one animation segment may be any integer number of animation segments greater than or equal to one, such as one animation segment, two animation segments, or three animation segments. The term “plurality of” refers to two or more. For example, a plurality of animation segments may be any integer number of animation segments greater than or equal to two, such as two animation segments or three animation segments. The term “each” refers to each of at least one. For example, each animation segment refers to each of a plurality of animation segments. If the plurality of animation segments are three animation segments, each animation segment refers to each of the three animation segments.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Information (including but not limited to user equipment information or user personal information), data (including but not limited to data for analysis, stored data, or displayed data), and signals (including but not limited to signals transmitted between a user terminal and another device) involved in the disclosure are all fully authorized by a user or relevant parties, and the collection, use, and processing of relevant data are required to comply with the relevant laws, regulations, and standards of the corresponding countries and regions.

1) Artificial intelligence (AI) is a theory, a method, a technology, and an application system, which use a digital computer or a machine controlled by the digital computer to simulate, extend, and expand human intelligence, perceive an environment, obtain knowledge, and use the knowledge to obtain an optimal result. In other words, AI is a comprehensive technology in computer science and attempts to understand the essence of intelligence and produce a new intelligent machine that can react in a mode similar to human intelligence. AI is to study design principles and implementation methods of various intelligent machines, to enable the machines to have functions of perception, inference, and decision-making.

The AI technology is a comprehensive discipline, and involves a wide range of fields including both the hardware-level technology and the software-level technology. Basic AI technologies generally include a sensor, a dedicated AI chip, cloud computing, distributed storage, a big data processing technology, a pre-trained model (PTM) technology, an operating/interaction system, electromechanical integration, and the like. The PTM is also referred to as a large model or a basic model, and may be widely applied to downstream tasks in various large directions of AI after fine adjustment. AI software technologies mainly include several major directions such as a computer vision technology, a speech processing technology, a nature language processing technology, and machine learning (ML)/deep learning.

2) Nature language processing (NLP) is an important direction in the field of computer science and AI. NLP studies various theories and methods that can implement effective communication between people and computers by using natural languages. NLP involves natural language, i.e., languages commonly used in daily life, and is closely related to linguistic research. Meanwhile, NLP involves key technologies for model training in AI fields such as computer science and mathematics. A PTM is evolved from a large language model (LLM) in the field of NLP.

3) A PTM, also referred to as a foundation model or a large model, is a deep neural network (DNN) having a large number of parameters, and is trained on massive unlabeled data. The PTM is enabled to extract common features from the data by using a function approximation capability of the DNN having a large number of parameters. After being processed by technologies such as fine-tuning, parameter-efficient fine-tuning (PEFT), and prompt-tuning, the PTM is applied to downstream tasks. Therefore, the PTM can achieve an ideal effect in few-shot or zero-shot scenes. The PTM is classified into a language model, a visual model, a voice model, a multi-modality model, and the like according to processed data modalities. For example, the language model is embeddings from language model (ELMO), bidirectional encoder representations from transformers (BERT), a generative pre-trained transformer (GPT), or the like.

4) An LLM is a large-scale deep learning model that typically employs an autoregressive loss as a training objective, enabling the LLM to predict a next token within a given context. In this way, the LLM learns to generate grammatically correct and semantically coherent text, so as to understand and generate human languages. By learning from a large volume of text data, the LLM can understand complex patterns and contextual relationships in language, thereby generating coherent and relevant text. A key characteristic of the LLM is the scale thereof, which typically includes billions or even trillions of parameters. This enables the LLM to capture and simulate the rich diversity and complexity of human languages. The LLM excels in various linguistic tasks, including but not limited to text generation, text understanding, machine translation, sentiment analysis, and the like. The multi-modality model refers to a model that constructs feature representations for two or more data modalities. The PTM is an important tool for outputting artificial intelligence generated content (AIGC), and may serve as a universal interface connecting a plurality of task-specific models. After fine-tuning, the LLM can be widely applied to downstream tasks. The NLP technology usually includes technologies, such as text processing, semantic understanding, machine translation, robot question answering, and knowledge mapping.

5) An animation is referred to as the first animation and the second animation described in the embodiments of the disclosure, and is a visual art form that plays a video composed of a series of consecutive images or frames at a particular quantity of frames per second, thereby creating an illusion of movement or change. These images or frames may be hand-drawn, computer-generated, or captured through photography or other technical means. In the fields of computer science and digital media, the animation typically involves the use of software tools and programming languages to create and control these image sequences. The animation may be configured for various purposes, including entertainment, education, advertising, simulation, visualization, and the like. The first animation and the second animation described in the embodiments of the disclosure are final animation products obtained by executing animation generation code. The content of the first animation is completely consistent with the description of a first description text, and accurately reproduces desired visual effects and storylines.

The PTM, also referred to as a foundation model or a large model, is a DNN having a large number of parameters, and is trained on massive unlabeled data. The PTM is enabled to extract common features from the data by using a function approximation capability of the DNN having a large number of parameters. After being processed by technologies such as fine-tuning, PEFT, and prompt-tuning, the PTM is applied to downstream tasks. Therefore, the PTM may achieve an ideal effect in few-shot or zero-shot scenes. The PTM may be classified into a language model, a visual model, a voice model, a multi-modality model, and the like according to processed data modalities. The multi-modality model refers to a model that constructs feature representations for two or more data modalities. The PTM is an important tool for outputting AIGC, and may serve as a universal interface connecting a plurality of task-specific models.

ML is a multi-field interdiscipline, and relates to a plurality of disciplines such as the probability theory, statistics, the approximation theory, convex analysis, and the algorithm complexity theory. In the ML, how a computer simulates or implements learning behaviors of humans is specifically studied, to obtain new knowledge or skills, and reorganize an existing knowledge structure to continuously improve performance of the computer. The ML is the core of the AI and a fundamental way to make computers intelligent, which is applied to all fields of the AI. The ML and the deep learning generally include technologies such as an artificial neural network, a confidence network, reinforcement learning, transfer learning, inductive learning, and learning from demonstration. The PTM is the latest advancement in deep learning and integrates the aforementioned technologies.

The emergence of the LLM has driven content creation, including films, animations, and games, into a new era. In some embodiments, an animation generation method based on an LLM-Agent system is proposed, which aims to convert a given description text into a 3D-rendered animation. This method can not only accurately control virtual objects and scene elements required to appear in the animation simultaneously, but also enable the content in the animation to match that described in the description text, while maintaining narrative coherence and scene consistency in the animation. The animation generation method provided by the embodiments of the disclosure will be described in detail below based on AI technologies.

The animation generation method provided by some embodiments can be performed by a computer device. In some embodiments, the computer device may be a terminal or a server.

In some embodiments, the server is an independent physical server, a server cluster composed of a plurality of physical servers or a distributed system, or a cloud server that provides basic cloud computing services such as a cloud service, a cloud database, cloud computing, a cloud function, cloud storage, a network service, cloud communication, a middleware service, a domain name service, a security service, a content delivery network (CDN), a big data platform, and an AI platform. In some embodiments, the terminal is a smartphone, a tablet computer, a notebook computer, a desktop computer, a smart speaker, a smart watch, a smart voice interaction device, a smart household appliance, an on-board terminal, or the like. This is not limited thereto.

In some embodiments, the computer program may be deployed in one computer device for execution, or deployed in a plurality of computer devices at one location for execution, or distributed in a plurality of computer devices at a plurality of locations and connected via a communication network. The plurality of computer devices at the plurality of locations and connected via the communication network can form a blockchain system.

According to the solutions provided in one or more embodiments, when an animation needs to be generated, only a description text for describing the animation needs to be provided. A specific function library to be used to generate the animation is intelligently predicted according to the description text. Then, a specific function in the function library to be used to generate the animation is intelligently predicted according to the description text. Then, executable animation generation code is intelligently generated according to a selected first function. The animation generation code is configured for invoking the intelligently selected function to generate the animation. Therefore, a corresponding animation may be obtained by executing the animation generation code. Since the function used for generating the animation is intelligently selected according to the description text, the animation generated by invoking the function conforms to content described by the description text, so that the matching animation is automatically generated based on the description text. The animation production process is more intelligent and automatic, thereby improving the animation generation efficiency.

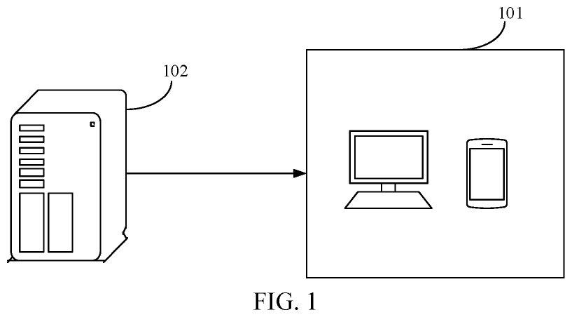

FIG. 1 is a schematic diagram of an implementation environment according to one or more embodiments. Referring to FIG. 1, the implementation environment includes a terminal 101 and a server 102. The terminal 101 is connected to the server 102 via a wireless or wired network.

For ease of understanding, a plurality of function libraries, an animation guidance agent, a decision agent corresponding to each function library, and a code generation agent that are involved in the embodiments of the disclosure are first briefly described. Functions in the function library are configured for generating an animation, and the functions have different functionality for being responsible for different tasks in the animation generation process. The animation guidance agent is configured to select a function library that needs to be used for generating an animation corresponding to a description text. The decision agent is configured to select, from the function library, a function that needs to be used for generating an animation corresponding to the description text. The code generation agent is configured to generate executable code, and the executable code is configured for generating an animation.

In some embodiments, as shown in FIG. 1, the server 102 stores the plurality of function libraries, the animation guidance agent, the decision agent corresponding to each function library, and the code generation agent. In some embodiments, a user enters a first description text in the terminal 101, and the terminal 101 transmits an animation generation request carrying the first description text to the server 102. After receiving the animation generation request, the server 102 generates corresponding animation generation code based on the first description text by using the animation guidance agent, the decision agent, and the code generation agent. The animation generation code is configured for invoking the functions in the plurality of function libraries to generate an animation. The server 102 executes the animation generation code to obtain a first animation, and returns the first animation to the terminal 101. After receiving the first animation, the terminal 101 may present the first animation to the user.

In some embodiments, as shown in FIG. 1, an animation production application runs in the terminal 101, the terminal 101 stores the plurality of function libraries, and the server 102 stores the animation guidance agent, the decision agent corresponding to each function library, and the code generation agent. In some embodiments, a user enters a first description text in the terminal 101, and the terminal 101 transmits an animation generation request carrying the first description text to the server 102. After receiving the animation generation request, the server 102 generates corresponding animation generation code based on the first description text by using the animation guidance agent, the decision agent, and the code generation agent. The animation generation code is configured for invoking the functions in the plurality of function libraries to generate an animation. The server 102 returns the animation generation code to the terminal 101. After receiving the animation generation code, the terminal 101 may obtain the first animation by executing the animation generation code in the animation production application, and then present the first animation to the user.

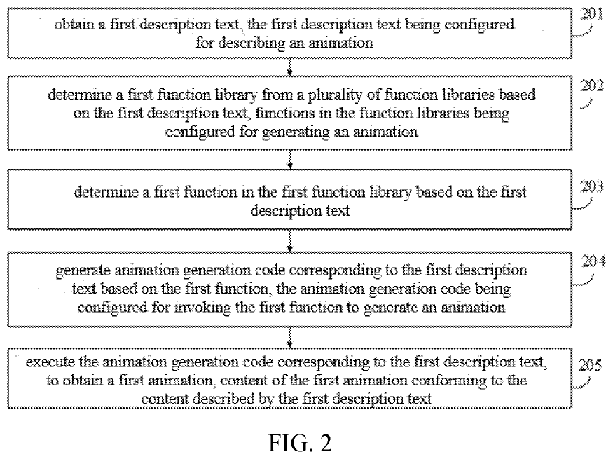

FIG. 2 is a flowchart of an animation generation method according to one or more embodiments. One or more embodiments according to FIG. 2 may be performed by a computer device. Referring to FIG. 2, the method includes:

201: A computer device obtains a first description text, the first description text being configured for describing an animation.

The first description text is configured for describing content that needs to be presented in a to-be-generated animation.

In some embodiments, the first description text may be entered into the computer device by a user. For example, when the user has determined what content is to be presented in an animation, the user enters a description text capable of describing such content into the computer device. In some embodiments, the first description text may be recognized or captured by the computer device from multimedia data. A manner of obtaining the first description text is not limited in the embodiments of the disclosure.

In some embodiments, the first description text is text information provided by the user or the computer device, for describing content that needs to be presented in the to-be-generated animation. The text may be manually entered by the user, or may be automatically recognized or captured by the computer device from other multimedia data. A main objective thereof is to provide clear guidance and description for animation generation, and help a computer or animation production software understand user requirements, so as to generate animation content that meets user expectations.

202: The computer device determines a first function library from a plurality of function libraries based on the first description text, functions in the function libraries being configured for generating an animation.

In some embodiments, each function library has a corresponding decision agent. An animation guidance agent is configured to determine the function libraries, and a decision agent is configured to determine a function.

In some embodiments, after obtaining the first description text, the computer device provides the first description text to the animation guidance agent, and the animation guidance agent may determine the first function library from the plurality of function libraries based on the first description text.

In some embodiments, the plurality of function libraries are predefined function libraries. For example, an animation production application runs in the computer device, and the plurality of function libraries may be predefined in the animation production application, so as to be directly invoked during subsequent animation generation. The first function library is a function library needing to be used for generating an animation matching the first description text. There may be one or more first function libraries. For example, the plurality of function libraries include function library 1 and function library 2. If the animation guidance agent determines that function library 1 is the first function library, it indicates that only function library 1 needs to be used for generating the animation matching the first description text, while function library 2 does not need to be used.

In some embodiments, the animation guidance agent is configured to determine a function library corresponding to any description text. Each function library further has a corresponding decision agent, and the decision agent corresponding to any function library is configured to determine, in the function library, a function corresponding to any description text. In some embodiments, the animation guidance agent and the decision agent may both belong to an LLM.

In some embodiments, the computer device includes a plurality of function libraries, and each function library includes a group of functions for generating an animation. The functions may have different functionality, such as creating an animation object, setting an animation attribute, and controlling animation playback. Each function library has a corresponding decision agent. The decision agent is an intelligent assembly capable of generating an animation by selecting a suitable function according to an input description text. This agent may be an ML model or a rule-based system. The animation guidance agent is a higher-layer intelligent assembly, and is responsible for selecting, from the plurality of function libraries, a function library most suitable for a current task. The animation guidance agent may be an ML model or a rule-based system. The computer device obtains a first description text. The text describes content that the user intends to present in the animation. The text may be manually entered by the user, or may be automatically recognized or captured by the computer device from other multimedia data. The computer device provides the first description text to the animation guidance agent. The animation guidance agent analyzes user requirements according to the text, and selects, from the plurality of function libraries, a function library most suitable for a current task. The animation guidance agent determines the first function library from the plurality of function libraries based on the first description text. The function library includes a group of functions that can meet user requirements. Once the first function library is determined, the computer device may select a specific function to generate an animation by using the decision agent in the function library. The decision agent selects a suitable function to generate the animation based on the first description text.

In some embodiments, the animation guidance agent is a high-level intelligent assembly, responsible for understanding user requirements and intentions, and selecting, from the plurality of function libraries, a function library most suitable for a current task. This agent usually receives a description text provided by the user, analyzes text content, and then guides an animation generation process according to an analysis result. The main functionality of the animation guidance agent is to select a suitable function library to generate an animation according to user requirements. This agent may use an NLP technology to understand text, and then use an ML model or a rule-based system to make a decision.

In some embodiments, the decision agent is an intelligent assembly associated with a particular function library, and is responsible for selecting a specific function in the function library to generate an animation. Each function library has a corresponding decision agent, which knows the functionality and application scenes of the functions in the function library. The main functionality of the decision agent is to select, in the selected function library, a suitable function to execute an animation generation task according to an instruction of the animation guidance agent and user requirements. This agent may use the ML model to predict an optimal function, or the rule-based system to make a decision.

In some embodiments, the animation guidance agent and the decision agent are two intelligent assemblies for generating animations in the fields of computer graphics and AI. The agents have different responsibilities and functionality. The two agents work together, so that the computer device can automatically select a suitable function library and function to generate an animation according to user requirements. The animation guidance agent is responsible for macroscopically making a decision to select a function library, and the decision agent is responsible for microscopically making a decision to select a specific function.

As an example, it is assumed that there is a computer device, which has a plurality of function libraries. Each function library includes a group of functions for generating different types of animations. A character animation library includes functions for creating and controlling a character animation, such as walking, running, and jumping. An environment animation library includes functions for creating and controlling an environment element animation, such as a weather change, a water flow, and fire. An effect animation library includes functions for creating various visual effects, such as explosion, a light effect, and a particle effect. Each function library has a corresponding decision agent, and these agents know function functionality and application scenes in the respective libraries. Currently, a user enters a first description text: “I need an animation, to present a character walking in a forest and suddenly encountering a heavy rain”. The computer device provides the text to the animation guidance agent. The animation guidance agent understands text content by using an NLP technology, and analyzes that an animation needed by the user includes character walking and raining scenes. Based on the information, the animation guidance agent performs selection from the plurality of function libraries. The character animation library may be preferentially considered since the text mentions character walking, and the environment animation library also needs to be considered since the text mentions raining. Once the animation guidance agent determines the character animation library and the environment animation library as the first function library, the animation guidance agent transmits information of these libraries to the corresponding decision agents. The decision agent of the character animation library selects a function related to character walking, for example, a function “character walking animation”. The decision agent of the environment animation library selects a function related to raining, such as a raining animation function. The two decision agents may further adjust parameters of the functions, to ensure natural and smooth animation. For example, the character walking animation function may be adjusted to adapt to the slippery ground caused by rain, while the raining animation function may be adjusted to match visual effects of the forest environment. Finally, the computer device generates, by using these selected functions, an animation that conforms to the description of the user, and displays a scene in which a character walks in a forest and encounters a heavy rain.

In this way, the method for determining, by the computer device, a first function library from a plurality of function libraries based on a first description text can significantly improve the efficiency and accuracy of animation generation. The animation guidance agent and the decision agent work together, so that the animation generation process is intelligently managed. The animation guidance agent can understand user requirements, and select a most suitable function library by analyzing the first description text, thereby reducing a complex process of manually selecting a function library, and improving working efficiency. The decision agent selects, in the selected function library, a most suitable function to generate an animation according to a specific user requirement, thereby ensuring that the quality of the animation meets user expectations. It can further adapt to different animation requirements, thereby improving the flexibility and scalability of animation generation. The method for determining a first function library based on a first description text not only improves the efficiency and accuracy of animation generation, but also improves system flexibility and scalability, and provides a more intelligent and efficient solution for animation production.

203: The computer device determines a first function in the first function library based on the first description text.

In some embodiments, after determining a first function library, the computer device provides a first description text to a decision agent corresponding to the first function library, and the decision agent determines a first function in the first function library according to the first description text.

In some embodiments, the first function library includes a plurality of functions. Each function is configured for generating an animation, but each function is separately responsible for different functionality in the animation generation process. The first function is a function needing to be used for generating an animation matching the first description text. There may be one or more first functions. For example, the first function library includes functions 1 to 5. If the decision agent determines that function 1 and function 5 are the first functions, it indicates that only function 1 and function 5 need to be used to generate the animation matching the first description text, while function 2, function 3, and function 4 do not need to be used.

In some embodiments, the computer device determines, by the decision agent corresponding to the first function library, the first function in the first function library based on the first description text. The computer device needs to determine which function library is most suitable for a current animation generation task. This is usually completed by the animation guidance agent, which may analyze the first description text, understand user requirements, and select a most suitable function library. Once the first function library is determined, the computer device transfers the first description text to the decision agent corresponding to the function library. The decision agent is specially responsible for selecting a suitable function in the function library. The decision agent receives and further analyzes the first description text. Based on analysis on the first description text, the decision agent searches the first function library for a most suitable function. In this selection process, an optimal function is predicted by matching functional descriptions of functions with user requirements, or by using an ML model. After selecting the first function, the decision agent may further adjust parameters of the function, to ensure that the generated animation can more accurately reflect user requirements. This may include adjusting a speed, strength, duration, and the like of the animation. The computer device generates the animation by using the selected first function. This process may involve invoking other related functions in the function library, to complete production of the animation. An intelligent decision process uses NLP and ML technologies, so that the computer device can automatically select and adjust functions according to user requirements, thereby generating a high-quality animation.

As an example, it is assumed that there is a computer device, which has a plurality of function libraries. Each function library includes a group of functions for generating different types of animations. A character animation library includes functions for creating and controlling a character animation, such as walking, running, and jumping. An environment animation library includes functions for creating and controlling an environment element animation, such as a weather change, a water flow, and fire. An effect animation library includes functions for creating various visual effects, such as explosion, a light effect, and a particle effect. Each function library has a corresponding decision agent, and these agents know function functionality and application scenes in the respective libraries. A user enters a first description text: “I need an animation, to present a character walking in a forest and suddenly encountering a heavy rain”. The computer device provides the text to the animation guidance agent. The animation guidance agent understands text content by using an NLP technology, and analyzes that an animation needed by the user includes character walking and raining scenes. The animation guidance agent performs selection from the plurality of function libraries. The character animation library may be preferentially considered since the text mentions character walking, and the environment animation library also needs to be considered since the text mentions raining. Once the animation guidance agent determines the character animation library and the environment animation library as the first function library, the animation guidance agent transmits information of these libraries to the corresponding decision agents. The decision agent of the character animation library selects a function related to character walking, for example, a function “character walking animation”. The decision agent of the environment animation library selects a function related to raining, such as a function “raining animation”. The two decision agents may further adjust parameters of the functions, to ensure natural and smooth animation. For example, the character walking animation function may be adjusted to adapt to the slippery ground caused by rain, while the raining animation function may be adjusted to match visual effects of the forest environment. The computer device generates, by using these selected functions, an animation that conforms to the description of the user, and displays a scene in which a character walks in a forest and encounters a heavy rain.

In this way, the computer device determines the first function in the first function library based on the first description text by using the decision agent corresponding to the first function library, so that levels of intelligence and personalization of animation generation can be significantly improved. In this process, through in-depth analysis and understanding of the decision agent, user requirements can be accurately matched with specific functions in the function library, thereby ensuring that the generated animation not only meets user expectations, but also meets a professional standard in terms of quality and effect. This not only reduces tedious processes of manually selecting and adjusting functions, thereby improving working efficiency, but also improves system flexibility and scalability, so that the computer device can adapt to various complex animation requirements. The method for determining a first function based on a first description text not only improves the efficiency and accuracy of animation generation, but also improves system flexibility and scalability, and provides a more intelligent and efficient solution for animation production.

204: The computer device generates animation generation code corresponding to the first description text based on the first function, the animation generation code being configured for invoking the first function to generate an animation.

In some embodiments, after determining a first function, the computer device provides the first function to a code generation agent, the code generation agent generates animation generation code according to the first function, and the animation generation code is executable code. The code generation agent is configured to generate code.

In some embodiments, the code generation agent is configured to generate corresponding animation generation code according to any function. The code generation agent belongs to an LLM.

In some embodiments, the computer device determines, by the decision agent, a first function most suitable for a current animation generation task. The function is selected from the first function library based on analysis and understanding of the first description text. Once the first function is determined, the computer device provides the function to the code generation agent. The code generation agent is an assembly specially responsible for converting a function into executable code. After receiving the first function, the code generation agent generates corresponding animation generation code according to a definition and functionality of the function. The code is executable, and may be directly configured for invoking the first function to generate an animation. The generated animation generation code is executed by the computer device, so as to invoke the first function to start generating the animation. The code generation agent may be an LLM. The LLM has a strong NLP capability, can understand a definition and context of a function, and generate code meeting requirements. The computer device can automatically convert user requirements into executable code, so as to generate an animation meeting user expectations.

As an example, it is assumed that there is a computer device, which has a function library that includes functions for generating various animations. Currently, a user enters a first description text: “I need an animation, to present a character walking in a forest and suddenly encountering a heavy rain”. The computer device analyzes the description text by the decision agent, and selects a most suitable function library and function. Then, the code generation agent generates corresponding animation generation code according to the selected function. The computer device executes the animation generation code, invokes a corresponding function, and generates the first animation. The animation presents a scene in which a character walks in a forest and suddenly encounters a heavy rain, conforming to content described in the first description text. It can be seen how the computer device executes the animation generation code corresponding to the first description text, to obtain the first animation conforming to the content of the description text.

205: The computer device executes the animation generation code corresponding to the first description text, to obtain a first animation, content of the first animation conforming to content described by the first description text.

In some embodiments, after obtaining animation generation code, the computer device executes the animation generation code to invoke the first function to generate a first animation. Since the first function is a function that needs to be used to generate an animation matching the first animation description, content of the first animation generated by invoking the first function matches content described by the first description text.

In some embodiments, the computer device executes the animation generation code corresponding to the first description text, to obtain the first animation, and ensures that content of the first animation conforms to content of the first description text. By means of the foregoing operations, the computer device has generated the animation generation code corresponding to the first description text. The code is automatically generated according to user requirements and the selected first function, and includes all instructions and parameters required for generating an animation. The computer device needs to have a suitable execution environment to execute the animation generation code. This may include a necessary software library, an API, a rendering engine, and the like, to ensure that the code can correctly invoke the first function and generate the animation. The computer device executes the animation generation code. During code execution, the first function and other related functions are invoked in a predetermined sequence, to execute various parts of the animation. For example, the code may first invoke a function to create a background of an animation, then create a role, set an action of the animation, and finally add an effect and save the animation. During code execution, a key part is to invoke the first function. The function is obtained through analysis according to the first description text, and can generate animation content matching user requirements. By invoking this function, the computer device can ensure that the generated animation content conforms to the content described by the first description text.

As an example, it is assumed that there is a computer device, which has a plurality of function libraries. Each function library includes a group of functions for generating different types of animations. A character animation library includes functions for creating and controlling a character animation, such as walking, running, and jumping. An environment animation library includes functions for creating and controlling an environment element animation, such as a weather change, a water flow, and fire. An effect animation library includes functions for creating various visual effects, such as explosion, a light effect, and a particle effect. A user enters a first description text: “I need an animation, to present a character walking in a forest and suddenly encountering a heavy rain”. The computer device first obtains the first description text entered by the user, and this text describes animation content expected by the user. The computer device analyzes the first description text to understand user requirements. The computer determines, according to the character and the forest background mentioned in the text, that the character animation library and the environment animation library need to be used. After determining the first function library, the computer device further analyzes the first description text, and determines specific functions needing to be used in these function libraries. For example, a function “character walking” is selected from the character animation library, and a function “raining” is selected from the environment animation library. The computer device generates corresponding animation generation code according to the selected functions. The code includes instructions for invoking these functions, to generate an animation meeting user requirements. The computer device executes the generated animation generation code, invokes corresponding functions, and starts to generate an animation. The process may involve interaction with other functions or assemblies, to ensure the completeness and quality of the animation. The computer device generates the first animation. The animation presents a scene in which a character walks in a forest and suddenly encounters a heavy rain, conforming to content described in the first description text.

According to the animation generation method provided in one or more embodiments, when an animation needs to be generated, only a description text for describing the animation needs to be provided. An animation guidance agent intelligently predicts, according to the description text, a specific function library to be used to generate the animation. Then, a decision agent corresponding to the function library intelligently predicts, according to the description text, a specific function in the function library to be used to generate the animation. Then, a code generation agent intelligently generates, according to the selected function, executable animation generation code. The animation generation code is configured for invoking the intelligently selected function to generate the animation. Therefore, a corresponding animation may be obtained by executing the animation generation code. Since the function used for generating the animation is intelligently selected according to the description text, the animation generated by invoking the function conforms to content described by the description text, so that the matching animation is automatically generated based on the description text. The animation production process is more intelligent and automatic, thereby improving the animation generation efficiency.

In some embodiments, a detailed description of a required animation is collected or compiled. The description text is required to include information such as a theme, a scene, a role, an action, an effect, duration, and a style of the animation. The description text may be from an animator, a director, or a client, or may be automatically generated by using an NLP technology.

In some embodiments, the first function library is determined from the plurality of function libraries based on the first description text, and specific requirements of the animation may be understood by further analyzing the first description text. This includes a theme, a style, a required effect, a role action, scene complexity, and the like of the animation. Key functionality that may be required in animation production is determined, for example, 3D modeling, skeleton animation, a particle effect, physical simulation, or a rendering technology. All available function libraries are listed. These function libraries may include a graphic library, an animation library, a game engine, a physical engine, and the like. Each function library is evaluated, and whether the functionality thereof covers factors such as an animation requirement, performance, usability, community support, document completeness, and license fee is considered. The animation requirement is matched with the functionality of each function library. Which function libraries can provide required functionality or whether a plurality of function libraries need to be combined to meet all requirements is determined. For example, if an animation needs advanced 3D rendering and physical simulation, a game engine such as Unity or Unreal Engine may need to be selected. The game engine provides abundant 3D functions and physical simulation tools. Technical feasibility of the selected function library, including a hardware requirement, programming language compatibility, and development environment setting, is analyzed. It is ensured that the selected function library can be integrated with an existing development tool and procedure, or migration costs and time are evaluated. Performance testing is performed on a candidate function library, especially performance when a complex animation scene is processed. The test may include key performance indicators such as a frame rate, memory use, and loading time. Factors such as license costs, development costs, and maintenance costs of the function library are considered. The total costs and potential benefits of long-term use of the function library are evaluated. Community activeness and provided support of the function library are considered. An active community and good technical support can greatly reduce problems in a development process. Based on the foregoing analysis, a function library most suitable for a first description text requirement is selected as a first function library. Reasons for selection, including technical advantages, cost benefits, community support, and the like, are determined. The first function library is integrated into a development environment. An initial test is performed to ensure that the function library can work normally and meet basic requirements of animation production. Therefore, a most suitable function library may be determined from the plurality of function libraries based on the first description text, to lay a solid foundation to subsequent animation production.

In some embodiments, a first function is determined in the first function library based on the first description text. Specific requirements of the animation, including details such as a scene, a role, an action, and an effect, are clarified by further analyzing the first description text. Key functionality and effects needed to implement these requirements are determined. A document of the first function library is researched to understand all functions and functional modules provided. Functions in the function library are sorted, so as to rapidly search for a function related to an animation requirement. According to the animation requirement, the function related to the animation requirement is screened. This may include a graphic rendering function, an animation transition function, a physical simulation function, a particle system function, and the like. Applicability of a function, flexibility of parameter configuration, and compatibility with another function are considered. The screened function is evaluated, and factors such as performance, usability, and customizability thereof are considered. Whether a function can achieve a required effect or whether a target needs to be achieved by combining a plurality of functions is evaluated. Several key functions are selected, and simple prototype code is written for testing. Whether an output of the function meets an expectation is observed, and parameters are adjusted to optimize the effect. It is determined, according to a result of a prototype test, which functions can be used in combination to achieve a more complex animation effect. An invoking sequence and interaction logic between the functions are designed. The selected function is optimized, to obtain performance and quality of the animation. The parameters of the function are adjusted to ensure smoothness and sense of reality of the animation. Best practices and advanced usage are learned with reference to documents and example code of the function library. It is ensured that the use of the function is further understood, and common errors and traps are avoided. A first function most suitable for implementing the first description text requirement is determined by comprehensively considering all factors. A selected indicator is determined, including the functionality, performance, usability, and the like of the function. The selected first function is integrated into the animation generation code. The code is executed, to verify whether the function can correctly generate an animation effect meeting the description text requirement. Therefore, a most suitable function may be determined in the first function library based on the first description text, to provide key technical support for animation generation.

In some embodiments, the computer device first needs to understand an interface of the first function, including an input parameter, an output result, and a behavior of the function. An animation logic flow is designed according to the first description text. This includes determining a start state, a transition state, and an end state of the animation. A movement trajectory, a timeline, and interaction logic of each element in the animation are planned. Parameters of the first function are configured according to an animation design. This may include setting a duration, a movement path, a speed curve, an effect parameter, and the like of the animation. It is ensured that the parameter configuration can achieve an expected animation effect. The computer device generates, according to the configured parameters, code for invoking the first function. This includes a function name, a parameter list, and any necessary context setting. The code is required to correctly initialize the animation environment, invoke the first function, and process the output of the function. The generated function invoking code is integrated with code of another animation element. This may include scene setting, role animation, effect rendering, and the like. It is ensured that all elements can work together to form a complete animation. The generated code is analyzed to identify a potential performance bottleneck. A code structure and an algorithm are optimized, to improve running efficiency and smoothness of the animation. The generated animation code is executed on the computer device, and whether an animation effect meets the first description text requirement is tested. The parameter and the code are adjusted until the animation effect reaches an expectation. Once the animation effect satisfies a requirement, the computer device outputs a generated code execution result as an animation file, such as a video file or an animated image sequence. It is ensured that a format of the outputted animation file meets a requirement and the quality reaches a standard. The computer device may generate, based on the first function, animation generation code corresponding to the first description text, and finally output animation content meeting requirements.

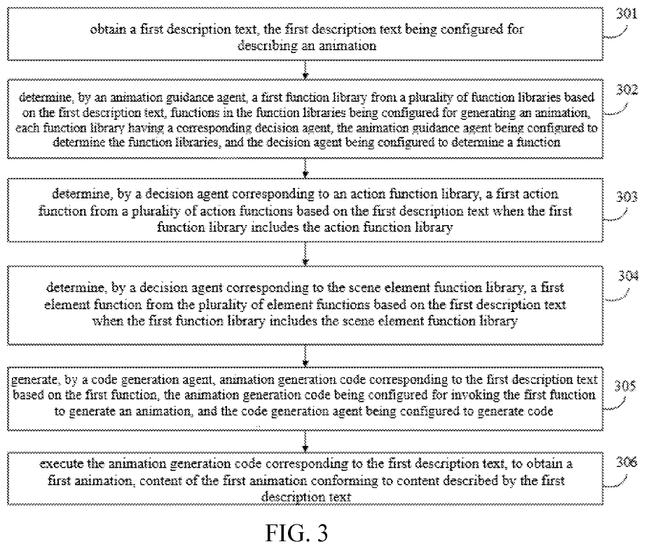

The foregoing embodiment is merely a brief description of the animation generation method. Based on the foregoing embodiment, the plurality of function libraries include an action function library and a scene element function library. For a detailed process of the animation generation method, refer to the following embodiment of FIG. 3. FIG. 3 is a flowchart of another animation generation method according to one or more embodiments. One or more embodiments according to FIG. 3 may be performed by a computer device. Referring to FIG. 3, the method includes:

301: A computer device obtains a first description text, the first description text being configured for describing an animation.

Operation 301 is similar to operation 201, and is not repeatedly described herein.

302: The computer device determines, by an animation guidance agent, a first function library from a plurality of function libraries based on the first description text, functions in the function libraries being configured for generating an animation, each function library having a corresponding decision agent, the animation guidance agent being configured to determine the function libraries, and the decision agent being configured to determine a function.

The animation guidance agent can perform initial analysis on the description text from a comprehensive perspective, to determine which function library or function libraries to be used to generate an animation. The animation guidance agent first determines which function library to use, and then determines which function or functions in the function library to be used by using a decision agent corresponding to the required function library. Compared with directly using the decision agent corresponding to each function library to determine whether functions in the respective library are needed and which functions to use, the manner in the embodiments of the disclosure can reduce the number of invocations of the decision agent, thereby improving decision efficiency. For example, if the quantity of the plurality of function libraries is 3 and the animation guidance agent selects only one function library as the function library, only a decision agent corresponding to this function library needs to be invoked subsequently, and decision agents corresponding to the remaining two function libraries do not need to be invoked, thereby effectively reducing the number of invocations.

In some embodiments, an objective of animation generation is to convert a description text related to a plurality of virtual objects into a 3D animation. Then, in a process of animation generation, actions to be performed by each virtual object and scene elements that play a decoration role in the animation need to be designed, to enhance attractiveness and vividness of the animation. Based on this, in some embodiments, the action function library and the scene element function library are predefined. For detailed content, refer to the following description.
(1) The plurality of function libraries include an action function library, and the action function library includes a plurality of action functions for controlling an action of a virtual object in an animation.

In some embodiments, the action functions in the action function library correspond to respective action categories, one action function belongs to one action category, and one action category includes at least one action function.

In some embodiments, the determining a first function in the first function library based on the first description text may be implemented by: determining, when the first function library includes the action function library, a first action function from the plurality of action functions based on the first description text.

As shown in the following Table 1, the action category includes a special movement, a linear movement, a curved movement, a jumping movement, an impact movement, and a state recovery operation. Taking a linear movement as an example, the linear movement includes an action function for implementing a constant-speed movement and an action function for implementing a variable-speed movement. In addition, other action categories also include at least one action function, and these action functions all belong to the action function library.

In some embodiments, the action functions correspond to respective action categories, one action function belongs to one action category, and one action category includes at least one action function. The determining a first action function from the plurality of action functions based on the first description text may be implemented by: determining a target action category from the plurality of action categories based on the first description text; and determining, based on the first description text, the first action function from action functions belonging to the target action category.

In some embodiments, the action functions in the action function library are classified into different action categories. For example, the action categories may include “movement”, “interaction”, “attack”, “defense”, “environmental change”, and the like. Each action category includes a plurality of related action functions. For example, there may be action functions such as “walking”, “running”, and “jumping” under the “movement” category. The computer device analyzes the first description text by using an NLP technology, to extract keywords and phrases related to an action. Then, these keywords are matched with a predefined action category, to determine which action category or action categories the action described in the text belongs to. For example, if the text mentions “a character walks in a forest”, the “movement” category may be matched. Based on a result of text analysis, the computer device determines the target action category most related to the first description text. This may involve setting of a priority. For example, if a plurality of actions are mentioned in the text at the same time, the computer device needs to determine which action is a main action or an action to be executed first. After determining a target action category, the computer device further determines a first action function from action functions belonging to the target action category. This may be implemented in multiple manners. For example, a most suitable action function is selected according to complexity of an action, an application scene, a user preference, and the like. Once the first action function is determined, the computer device may configure parameters of the function according to specific details in the first description text. For example, a movement speed, direction, amplitude, and the like are adjusted. Then, the computer device executes the action function to generate a corresponding animation effect. If the first description text includes a plurality of actions, the computer device may execute a plurality of action functions in sequence, to generate a series of animation effects, and combine the animation effects into a complete animation. Finally, the generated animation is outputted to a user.

As an example, when the first function library includes the action function library, the first action function is determined from the plurality of action functions based on the first description text. The computer device analyzes the first description text by using an NLP technology, to extract keywords and phrases related to an action. For example, if the first description text is “a character walks in a forest and suddenly encounters a heavy rain”, extracted keywords may include “walk”, “encounter”, “heavy rain”, and the like. The computer device performs semantic understanding on the extracted keywords, and determines action types represented by the keywords. For example, “walk” may correspond to the “movement” action, “encounter” may correspond to “interaction”, and “heavy rain” may correspond to the “weather change” action. The computer device matches the understood action type with the plurality of action functions in the action function library. The action function library may include various action functions, such as “moving character”, “character interaction”, and “changing the weather”. The computer device finds a most satisfied action function by comparing action types and functional descriptions of the action functions. When determining an action function, the computer device further needs to consider context of an action. For example, if a character walks in a forest, a movement function suitable for a forest environment may need to be selected instead of a movement function of a city or an indoor environment. Once the first action function is determined, the computer device may adjust parameters of the function according to specific details in the first description text. For example, a movement speed, the strength of weather change, and the like are adjusted, to ensure that the generated animation is more realistic and meets user requirements. The computer device confirms the selected first action function and uses the first action function to generate the animation generation code. This process may involve the combined use of the plurality of action functions, to achieve a complex animation effect. The computer device can determine the first action function in the action function library based on the first description text, to prepare for generating an animation meeting user requirements. This process shows how the computer device converts text descriptions into specific action functions by using NLP and semantic understanding technologies, to implement intelligent generation of an animation.
(2) The plurality of function libraries include a scene element function library, and the scene element function library includes a plurality of element functions for controlling a scene element in an animation.

In some embodiments, the scene element is configured for decorating or modifying a scene in an animation. For example, the scene element includes a lighting element, an effect element, focus switching of a camera, and the like. As shown in the following Table 1, the scene element function library includes an element function for switching a camera, an element function for implementing lighting illumination, an element function for implementing a particle effect, an element function for implementing a beam effect, an element function for drawing rainbow rain, an element function for adjusting sunlight, and the like.

In some embodiments, the plurality of function libraries include a scene element function library, and the scene element function library includes a plurality of element functions for controlling a scene element in an animation. The determining a first function in the first function library based on the first description text may be implemented by: determining, when the first function library includes the scene element function library, a first element function from the plurality of element functions based on the first description text.

In some embodiments, the determining a first element function from the plurality of element functions based on the first description text may be implemented by: determining, by the decision agent corresponding to the scene element function library, a first element function corresponding to at least one virtual object identifier based on the first description text and the at least one virtual object identifier, the virtual object identifier indicating a virtual object appearing in an animation, and the first element function corresponding to the virtual object identifier being configured for adding a scene element to the virtual object.

TABLE 1

| | Action | Action | Scene | Element |
|---|---|---|---|---|
| Action | category | function | element | function |
| 1 | Special | Do nothing | 1 | Switching |
| | movement | | | camera |
| 2 | Linear | Constant-speed movement and | 2 | Lighting |
| | movement | variable-speed movement | | illumination |
| 3 | Curved | Bezier curve movement, | 3 | Particle effect |
| | movement | S-curve movement, and | | |
| | | B-curve movement | | |
| 4 | Jumping | Jumping in place and | 4 | Beam effect |
| | movement | jumping forward | | |
| 5 | Impact | Falling down, knocking down | 5 | Rainbow rain |
| | movement | heavily, and knocking flying | | |
| 6 | State recovery | Standing up and landing from | 6 | Sunlight |
| | operation | the sky | | adjustment |

In some embodiments, the following processing may further be performed: determining, by the animation guidance agent, duration information based on the first description text.

In some embodiments, the duration information indicates duration of an animation that needs to be generated. Subsequently, generation of an animation corresponding to the duration may be determined according to the duration information.

In some embodiments, the animation guidance agent outputs guidance information and the duration information. The guidance information is configured for indicating which function library among the plurality of function libraries belongs to the first function library and which function library does not belong to the first function library. For example, the guidance information includes each function library identifier and a corresponding indication identifier. If an indication mark corresponding to a function library identifier is a first indication mark, it indicates that a function library indicated by the function library identifier belongs to the first function library. If an indication mark corresponding to a function library identifier is a second indication mark, it indicates that a function library indicated by the function library identifier does not belong to the first function library. For example, the first indication mark is “true”, and the second indication mark is “false”.

In some embodiments, a plurality of duration marks are predefined in the computer device. Each duration mark corresponds to a different frame duration. The duration information includes one of the plurality of duration marks. For example, the plurality of duration marks include “fast”, “moderate”, “slow”, “emphasized”, and the like.

In some embodiments, in addition to determining, according to the description text, a function library that needs to be invoked, the animation guidance agent can further determine, according to the description text, duration information of an animation that needs to be generated, so as to intelligently design the duration of the animation that needs to be generated, thereby improving the flexibility and diversity of animation generation.

In some embodiments, operation 302 includes: determining, by the animation guidance agent, a candidate function library from the plurality of function libraries based on the first description text; generating, by the animation guidance agent, a detection result based on the first description text and the candidate function library, the detection result indicating whether the candidate function library is accurate, and when the detection result indicates that the candidate function library is incorrect, the detection result further including an error reason; determining, when the detection result indicates that the candidate function library is accurate, the candidate function library as the first function library; and determining, by the animation guidance agent when the detection result indicates that the candidate function library is incorrect, a next candidate function library based on the first description text and the error reason, until the detection result indicates that a currently obtained candidate function library is accurate, and determining the currently obtained candidate function library as the first function library.

The processing of the animation guidance agent includes a decision process and a self-check process. In the decision process, the animation guidance agent determines a candidate function library that is intelligently selected. In the self-check process, the animation guidance agent detects the candidate function library selected by this agent, to determine whether the selection result is accurate. If the result is accurate, the currently selected candidate function library is used as a final function library. If the result is inaccurate, the animation guidance agent needs to enter the decision process again, re-select a candidate function library with reference to the first description text and the error reason, and enter the self-check process again, to detect the candidate function library selected at this time, until the selected candidate function library successfully passes the self-check, and the candidate function library passing the self-check successfully is used as a final function library.

To be specific, the animation guidance agent can perform self-reflection and correction on an output result of this agent, and the decision process and the self-check process are, in some embodiments, performed until it is determined that the output result of this agent has no error.

In some embodiments, after the animation guidance agent determines a function library according to a description text, the animation guidance agent further performs self-check on the selected function library, to detect whether a decision result thereof is accurate. If the decision result is incorrect, the animation guidance agent re-determines a function library according to the description text and a current error reason, until the currently determined function library passes self-check. Therefore, by adding a self-check procedure, it can be effectively ensured that the animation guidance agent selects a more accurate function library, thereby ensuring adaptation of a subsequently generated animation to the description text.

For ease of understanding, input and output in a decision process and a self-check process of the animation guidance agent are described below by using an example.

In the first decision process, the input of the animation guidance agent is: Description text: “The sky darkens, a vehicle equipped with spotlights slowly drives toward a vase, and the vehicle is under the focus of a camera.”

In the first decision process, the output of the animation guidance agent is: Action function library: “true”; Scene element function library: “false”; Duration information: “slow”.

In the first self-check process, the input of the animation guidance agent is: Description text: “The sky darkens, a vehicle equipped with spotlights slowly drives toward a vase, and the vehicle is under the focus of a camera.” Response result: Action function library: “true”; Scene element function library: “false”; Duration information: “slow”.

In the first self-check process, the output of the animation guidance agent is: Error; Error reason: “According to the description text, the ambient light is required to darken, but the scene element function library is not selected.”

In the second decision process, the input of the animation guidance agent is: Description text: “The sky darkens, a vehicle equipped with spotlights slowly drives toward a vase, and the vehicle is under the focus of a camera.”; Error reason: “According to the description text, the ambient light is required to darken, but the scene element function library is not selected.”

In the second decision process, the output of the animation guidance agent is: Action function library: “true”; Scene element function library: “true”; Duration information: “slow”.

In the second self-check process, the input of the animation guidance agent is: Description text: “The sky darkens, a vehicle equipped with spotlights slowly drives toward a vase, and the vehicle is under the focus of a camera.” Response result: Action function library: “true”; Scene element function library: “true”; Duration information: “slow”.

In the second self-check process, the output of the animation guidance agent is: Accurate.

303: The computer device determines, by a decision agent corresponding to an action function library, a first action function from a plurality of action functions based on the first description text when the first function library includes the action function library.

The plurality of function libraries include the action function library, and the action function library includes a plurality of action functions for controlling an action of a virtual object in an animation. If the first function library includes an action function library, to be specific, the action function library is required to generate an animation adapted to the first description text, a first action function is selected from the action function library by a decision agent corresponding to the action function library. The decision agent corresponding to the action function library may be referred to as an action decision agent, and a first function selected from the action function library may be referred to as the first action function.

In some embodiments, an action function library is predefined. An action function in the action function library can control an action of a virtual object in an animation. A suitable action function can be selected from the action function library by a decision agent according to a description text, to ensure that content presented after the action of the virtual object is controlled by invoking the action function conforms to content described in the description text. It is unnecessary to manually consider a suitable action function to be selected, thereby intelligently designing the action of the virtual object in the animation.

In some embodiments, the action functions in the action function library correspond to respective action categories, one action function belongs to one action category, and one action category includes at least one action function. Operation 303 includes: determining, by the decision agent corresponding to the action function library, a target action category from the plurality of action categories based on the first description text; and determining, by the decision agent corresponding to the action function library, the first action function from action functions belonging to the target action category based on the first description text.

To be specific, the action decision agent selects an action function in a hierarchical mode. First, an action category of a virtual object (e.g., a curved movement of a vehicle) is selected, and then a specific action function (e.g., an action function for S-curve movement) under the action category is selected. The hierarchical mode is a personified processing manner, and can reflect a thinking process of people. The personified thinking mode makes the decision process of the action decision agent more accurate and persuasive.

In some embodiments, action functions in an action function library have corresponding action categories. When selecting an action function, the decision agent first selects a suitable target action category from the plurality of action categories, and then selects a suitable action function from the plurality of action functions under the target action category. Therefore, a selection process of the action function is divided into two layers. The quantity of action functions to be screened by the decision agent can be reduced, and processing efficiency is improved. In addition, the decision agent can imitate human thinking, to first determine a type of an action to be performed and then determine a specific action to be performed, thereby improving accuracy of the decision agent.

In some embodiments, the determining a target action category from the plurality of action categories based on the first description text may be implemented by: obtaining a mapping relationship between preset description texts and the action categories, and searching the mapping relationship for a preset description text having similarity to the first description text greater than a similarity threshold; and determining an action category corresponding to the found preset description text as the target action category.

In some embodiments, operation 303 includes: determining, by the decision agent corresponding to the action function library, a first action function corresponding to at least one virtual object identifier based on the first description text and the at least one virtual object identifier, the virtual object identifier indicating a virtual object appearing in an animation, and the first action function corresponding to the virtual object identifier being configured for controlling an action of the virtual object.

In some embodiments, the at least one virtual object identifier is a pre-selected virtual object identifier. The virtual object indicated by the virtual object identifier is a virtual object that a user expects to appear in a to-be-generated animation.

In some embodiments, the decision agent corresponding to the action function library determines a first action function corresponding to at least one virtual object identifier based on the first description text and the at least one virtual object identifier. The user selects the at least one virtual object identifier. These identifiers indicate a virtual object that the user expects to appear in a to-be-generated animation. For example, the user may select a virtual object identifier such as “character”, “animal”, or “vehicle”. The computer device analyzes the first description text by using an NLP technology, to extract keywords and phrases related to an action. For example, if the first description text is “a character walks in a forest and suddenly encounters a heavy rain”, extracted keywords may include “walk”, “encounter”, “heavy rain”, and the like. Based on a result of text analysis, the computer device determines the target action category related to the first description text. For example, it is mentioned in the text that “walks” may correspond to the “movement” category, and “encounters a heavy rain” may correspond to the “environmental change” category. The computer device searches the action function library for an action function matching the target action category. For example, there may be action functions such as “walking”, “running”, and “jumping” under the “movement” category, and there may be action functions such as “raining”, “thundering”, and “lightning” under the “environmental change” category. The computer device associates at least one virtual object identifier with a corresponding action function. For example, an identifier of “character” is associated with an action function of “walking”, and an identifier of “forest” is associated with an action function of “raining”. The computer device executes the generated animation generation code and invokes the first action function to generate an animation. The animation presents an action performed by the virtual object in the animation, and conforms to content described by the first description text.

In some embodiments, the virtual object includes a dynamic virtual object and a static virtual object. The dynamic virtual object is a movable virtual object, for example, a person, a kitten, a puppy, or a vehicle appearing in the animation. The static virtual object is an immovable virtual object, for example, a tree, a house, or a pool appearing in the animation.

As an example, it is assumed that there is animation production software, which has a rich action function library, including various preset action functions, such as “walking”, “running”, “jumping”, “attack”, and “defense”. The user intends to generate an animation through the software to show a scene of a knight fighting on horseback on a battlefield. The user first selects virtual object identifiers in the software, such as “knight” and “war horse”. These identifiers indicate virtual objects that the user expects to appear in the animation. The user enters the first description text: “The knight rides a horse toward the enemy and waves a sword to attack.” The software analyzes the text through an NLP technology and extracts keywords such as “ride a horse”, “toward”, “wave”, and “attack”. Based on these keywords, the software determines the target action categories as “movement” and “attack”. The software searches the action function library for an action function matching the target action category. For example, the action function “ride a horse” is found under the “movement” category, and the action function “wave a sword” is found under the “attack” category. The software associates the identifier “knight” with the action function “wave a sword”, and associates the identifier “war horse” with the action function “ride a horse”. Based on an association between a virtual object identifier and an action function, the software determines that a first action function corresponding to “knight” is “wave a sword”, and a first action function corresponding to “war horse” is “ride a horse”. The software executes the generated animation generation code, and invokes the action functions “ride a horse” and “wave a sword” to generate an animation. The animation presents a scene of a knight riding a horse toward the enemy and waving a sword to attack, which is consistent with the content described in the first description text of the user. It can be seen how the computer device determines, by the decision agent corresponding to the action function library, a first action function corresponding to at least one virtual object identifier based on the first description text and the at least one virtual object identifier, so as to generate an animation meeting user requirements.

In this way, the decision agent corresponding to the action function library determines, based on the first description text and at least one virtual object identifier, a first action function corresponding to the at least one virtual object identifier. The decision agent further analyzes the first description text by using an NLP technology, to extract keywords and phrases related to an action, so as to precisely identify an animation scene and an action type expected by a user. Meanwhile, pre-selection of the virtual object identifier ensures that the decision agent can quickly locate an action function matching user requirements. By associating the virtual object identifier with the corresponding action function, the decision agent can automatically generate code for controlling the action of the virtual object, thereby reducing complexity and an error rate of manually writing code. In addition, this method further improves the flexibility and customizability of animation generation, and a user may select different virtual object identifiers and action functions according to own requirements, so as to create various animation effects. In conclusion, the decision agent corresponding to the action function library determines, based on the first description text and at least one virtual object identifier, a first action function corresponding to the at least one virtual object identifier, thereby providing an efficient, accurate, flexible, and customizable technical means for animation generation.

In some embodiments, a virtual object that needs to appear in an animation is further provided to the decision agent while a description text is provided to the decision agent, and the decision agent may determine an action function to be selected for each virtual object based on the description text, so as to intelligently design an action for each virtual object in the animation, thereby helping ensure richness of the generated animation.

In some embodiments, operation 303 includes: determining, by the decision agent corresponding to the action function library, a candidate action function from the plurality of action functions based on the first description text; generating, by the decision agent corresponding to the action function library, a detection result based on the first description text and the candidate action function, the detection result indicating whether the candidate action function is accurate, and when the detection result indicates that the candidate action function is incorrect, the detection result further including an error reason; determining, when the detection result indicates that the candidate action function is accurate, the candidate action function as the first action function; and determining, by the decision agent when the detection result indicates that the candidate action function is incorrect, a next candidate action function based on the first description text and the error reason, until the detection result indicates that a currently obtained candidate action function is accurate, and determining the currently obtained candidate action function as the first action function.

In some embodiments, the processing of the action decision agent includes a decision process and a self-check process. In the decision process, the action decision agent determines a candidate action function that is intelligently selected. In the self-check process, the action decision agent detects the candidate action function selected by this agent, to determine whether the selection result is accurate. If the result is accurate, the currently selected candidate action function is used as a final action function. If the result is inaccurate, the action decision agent needs to enter the decision process again, re-select a candidate action function with reference to the first description text and the error reason, and enter the self-check process again, to detect the candidate action function selected at this time, until the selected candidate action function successfully passes the self-check, and the candidate action function passing the self-check successfully is used as a final action function.

In some embodiments, the action decision agent first performs NLP on the first description text, to extract keywords and phrases related to an action. Based on the extracted keywords, the agent searches the action function library for a matching candidate action function. The candidate functions may be directly related to keywords, or may be indirectly related through semantic analysis. The agent detects the candidate action function, to determine whether this function accurately reflects the action described in the first description text. This may involve checking a plurality of aspects such as the functionality, parameter setting, and expected output of the function. If the detection result indicates that the candidate action function is inaccurate, the agent analyzes an error reason. This may include problems such as inappropriate function selection, incorrect parameter setting, and inconsistency of function functionality and text description. When the detection result indicates that the candidate action function is incorrect, the agent re-enters the decision process based on the first description text and the error reason, and selects a next candidate action function. The agent detects the re-selected candidate action function again, to determine whether this function is accurate. Once the detection result indicates that the currently obtained candidate action function is accurate, the agent determines this function as the first action function. If the candidate action function is still inaccurate, the agent continues the iterative selection and detection process until an accurate candidate action function is found. In an iterative process of decision and self-check, the action decision agent can ensure that a finally selected action function accurately reflects an action described in the first description text, thereby improving the accuracy and quality of animation generation.

As an example, it is assumed that there is animation production software. A user hopes to generate an animation by using the software, to show a scene of a character running and avoiding obstacles in a forest. The first description text entered by the user is: “The character runs quickly in the forest and avoids trees and stones.” The decision agent analyzes the text, to extract keywords “run”, “avoid”, “tree”, and “stone”. The agent detects whether the candidate action function accurately reflects the text description. For example, it is checked whether the function “run quickly” can simulate a running action of the character in the forest, and whether the function “avoid obstacles” can make the character avoid trees and stones. If the detection result indicates that a candidate action function is inaccurate, the agent analyzes an error reason. For example, the reason may be that an obstacle of a specific type may be avoided by default by the function “avoid obstacles”, and trees and stones in the forest may be avoided in a specific manner. Based on the error reason, the agent re-selects a candidate action function. For example, a function “advanced avoidance” that can self-define an avoidance manner is selected. The agent detects the re-selected candidate action function again, to ensure that the agent can accurately simulate an action of the character avoiding trees and stones in the forest. Once the detection result indicates that the candidate action function is accurate, the agent determines this function as the first action function. If the candidate action function is still inaccurate, the agent continues the iterative selection and detection process until an accurate candidate action function is found.

In this way, the decision agent corresponding to the action function library determines, based on the first description text, a candidate action function from the plurality of action functions, and determines the accuracy thereof through the self-check process. The decision agent further understands the first description text by using an NLP technology, and extracts key action information, so as to intelligently select the candidate action function in the action function library. The self-check process ensures that the selected action function can accurately reflect the text description. By using a detection result feedback mechanism, the agent can identify and correct an error in selection, so as to re-select a more suitable action function. Such an iterative process of decision and self-check not only improves the accuracy of action function selection, but also enhances the adaptability and flexibility of a system, so that animation generation is more efficient and precise.

In some embodiments, after the decision agent determines a function according to a description text, the decision agent further performs self-check on the selected function, to detect whether a decision result thereof is accurate. If the decision result is incorrect, the decision agent re-determines a function according to the description text and a current error reason, until the currently determined function passes self-check. Therefore, by adding a self-check procedure, it can be effectively ensured that the decision agent selects a more accurate function, thereby ensuring adaptation of a subsequently generated animation to the description text.

For ease of understanding, input and output in a decision process of the action decision agent are described below by using an example.

The input of the action decision agent is: Quantity of virtual objects: 3; Dynamic virtual objects: “kitten”, “puppy”, and “vehicle”; Static virtual objects: “vase”, “Christmas tree”, “stone carving”, and “sun”; Description text: “The sky darkens, a vehicle equipped with spotlights slowly drives toward a vase, and the vehicle is under the focus of a camera.”

The output of the action decision agent is: {Virtual object: “kitten”; Action category: “special movement”; Action function: “do nothing”; Function variable: “kitten”}; {Virtual object: “puppy”; Action category: “special movement”; Action function: “do nothing”; Function variable: “puppy”}; {Virtual object: “vehicle”; Action category: “linear movement”; Action function: “constant-speed movement”; Function variable: “vehicle”}.

In some embodiments, only an example where the first function library includes an action function library is used for description. Therefore, operation 303 needs to be performed.

In another embodiment, if the first function library does not include an action function library, operation 303 does not need to be performed.

304: The computer device determines, by a decision agent corresponding to the scene element function library, a first element function from the plurality of element functions based on the first description text when the first function library includes the scene element function library.

The plurality of function libraries include a scene element function library, and the scene element function library includes a plurality of element functions for controlling a scene element in an animation. If the first function library includes a scene element function library, to be specific, the scene element function library is required to generate an animation adapted to the first description text, a first scene element function is selected from the scene element function library by a decision agent corresponding to the scene element function library. The decision agent corresponding to the scene element function library may be referred to as a scene element decision agent, and a first function selected from the scene element function library may be referred to as the first scene element function.

In some embodiments, a scene element function library is predefined. An element function in the scene element function library can control a scene in an animation. A suitable element function can be selected from the scene element function library by a decision agent according to a description text, to ensure that content presented after the scene element in the animation is controlled by invoking the element function conforms to content described by the description text, so as to reasonably decorate the scene in the animation. Since it is unnecessary to manually consider a suitable element function, the scene in the animation is intelligently designed.

In some embodiments, the computer device first performs NLP on the first description text, to extract keywords and phrases related to a scene element. For example, if the text describes “a sunny beach”, the extracted keywords may include “sunshine”, “beach”, “blue sky”, and the like. The computer device accesses a scene element function library, which includes a plurality of functions for controlling scene elements in the animation, such as “sunshine irradiation”, “wave slapping”, and “blue sky and white clouds”. Based on a result of text analysis, the computer device searches the scene element function library for element functions matching the extracted keywords, such as the function “sunshine irradiation” matching “sunshine”, the function “wave slapping” matching “beach”, and the function “blue sky and white clouds” matching “blue sky”. A decision agent corresponding to the scene element function library, namely an element decision agent, evaluates the matched element functions and determines which functions can most accurately reflect the scene elements in the first description text. The element decision agent selects the most suitable element functions as the first element functions based on the evaluation result. These functions will be configured for controlling the scene elements in the animation to generate an animation environment adapted to the first description text. The computer device executes the generated animation generation code, invokes the first element functions, and generates the scene elements in the animation. These elements jointly form an animation environment consistent with the description in the first description text.

As an example, it is assumed that there is animation production software. A user hopes to generate an animation by using the software, to show a scene of a peaceful forest morning. The first description text entered by the user is: “Morning sunshine filters through the leaves onto the forest path, and birds sing on the branches.” The element decision agent of the software analyzes the text and extracts keywords “morning”, “sunshine”, “leaves”, “forest path”, “birds”, and “sing”. A scene element function library is accessed, which includes a plurality of functions for controlling scene elements in the animation, such as “sunshine penetration”, “leaf swaying”, “path laying”, “bird flying”, and “bird song sound effect”. Based on a result of text analysis, the agent searches the scene element function library for element functions matching the extracted keywords, such as the function “sunshine penetration” matching “sunshine”, the function “leaf swaying” matching “leaves”, the function “path laying” matching “forest path”, the function “bird flying” matching “birds”, and the function “bird song sound effect” matching “sing”. The element decision agent evaluates the matched element functions and determines which functions can most accurately reflect the scene elements in the first description text. For example, the agent may select the function “sunshine penetration” to simulate an effect of sunshine filtering through leaves, the function “leaf swaying” to simulate the dynamics of leaves in the breeze, the function “path laying” to create the appearance of the forest path, the function “bird flying” to show the activities of birds on the branches, and the function “bird song sound effect” to add the singing sound of birds. The element decision agent selects the most suitable element functions as the first element functions based on the evaluation result. These functions will be configured for controlling the scene elements in the animation to generate a scene of a forest morning consistent with the description in the first description text. The generated animation generation code is executed, the first element functions are invoked, and the scene elements in the animation are generated. These elements jointly form a scene of a peaceful and vivid forest morning, which is consistent with the description in the first description text of the user. It can be seen how the element decision agent determines the first element function through text analysis and element function matching and selection, thereby preparing for generating animation scene elements that meet user requirements.

In this way, when the first function library includes the scene element function library, the computer device determines, by the decision agent corresponding to the scene element function library, a first element function from the plurality of element functions based on the first description text, thereby significantly improving the automation and accuracy of animation scene generation. Specifically, the decision agent uses an NLP technology to further understand the first description text and extract keywords and phrases related to scene elements, so as to intelligently select element functions matching the text description from the scene element function library. This selection process not only improves the accuracy and consistency of scene elements, but also enhances the immersion and realism of an animation scene. Through this method, the computer device can quickly generate animation scenes meeting user requirements, reduce the workload of manual adjustment and optimization, and improve the efficiency and quality of animation production.

In some embodiments, operation 304 includes: determining, by the decision agent corresponding to the scene element function library, a first element function corresponding to at least one virtual object identifier based on the first description text and the at least one virtual object identifier, the virtual object identifier indicating a virtual object appearing in an animation, and the first element function corresponding to the virtual object identifier being configured for adding a scene element to the virtual object.

The at least one virtual object identifier is a pre-selected virtual object identifier. The virtual object indicated by the virtual object identifier is a virtual object that a user expects to appear in a to-be-generated animation.

In some embodiments, the decision agent corresponding to the scene element function library determines a first element function corresponding to at least one virtual object identifier based on the first description text and the at least one virtual object identifier. The decision agent first performs NLP on the first description text to extract keywords and phrases related to scene elements and virtual objects. For example, if the text describes “a character walking in the rain”, the extracted keywords may include “character”, “rain”, and “walk”. The decision agent identifies the virtual object identifier mentioned in the text. These identifiers are pre-selected and correspond to virtual objects that the user expects to appear in the animation. For example, the virtual object identifier may be “main character”, “supporting character”, or the like. Based on a result of text analysis and the virtual object identifier, the decision agent searches the scene element function library for element functions matching the extracted keywords, such as the function “rain effect” matching “rain” and the function “walking animation” matching “walk”. The decision agent evaluates the matched element functions and determines which functions can most accurately add corresponding scene elements to the virtual objects. For example, the agent may select the function “rain effect” to simulate a rainy environment and the function “walking animation” to show a walking action of the character. The decision agent selects the most suitable element functions as the first element functions based on the evaluation result. These functions will be configured for adding scene elements to the virtual objects to generate an animation scene consistent with the description in the first description text. The computer device executes the generated animation generation code, invokes the first element functions, and adds scene elements to the virtual objects. These elements jointly form an animation scene consistent with user description, where behaviors of the virtual objects and environmental effects are accurately presented. The computer device can determine the first element function in the scene element function library based on the first description text and the virtual object identifiers, so as to add suitable scene elements to the virtual objects. How the computer device uses the scene element function library, the decision agent, and an NLP technology to convert user requirements into specific animation scene elements and create a vivid and description-compliant animation environment for virtual objects is described.

As an example, it is assumed that there is animation production software. A user hopes to generate an animation by using the software, to show a scene of a character running and avoiding obstacles in a forest. The first description text entered by the user is: “The character runs quickly in the forest and avoids trees and stones.” The virtual object identifier pre-selected by the user is “main character”. The decision agent analyzes the text, to extract keywords “run”, “avoid”, “tree”, and “stone”. The decision agent identifies the virtual object identifier “main character” mentioned in the text. Based on a result of text analysis and the virtual object identifier, the agent searches the scene element function library for element functions matching the extracted keywords, such as the function “run quickly” matching “run”, the function “avoid obstacles” matching “avoid”, and the function “trees and stones” matching “tree” and “stone”. The agent evaluates the matched element functions and determines which functions can most accurately add corresponding scene elements to “main character”. For example, the agent may select the function “run quickly” to simulate a running action of a main character, the function “avoid obstacles” to show behaviors of the main character for avoiding trees and stones, and the function “trees and stones” to create an obstacle environment in the forest. The agent selects the most suitable element functions as the first element functions based on the evaluation result. These functions will be configured for adding scene elements to “main character” to generate an animation scene consistent with the description in the first description text. The first element functions are invoked, and scene elements are added to “main character”. These elements jointly form an animation scene of a character running and avoiding obstacles in the forest, which is consistent with the description in the first description text of the user.

In some embodiments, a virtual object that needs to appear in an animation is further provided to the decision agent while a description text is provided to the decision agent, and the decision agent may determine an action function to be selected for a specific virtual object based on the description text, so as to intelligently add corresponding scene elements to specific virtual objects in the animation, thereby helping ensure richness of the generated animation.

In some embodiments, operation 304 includes: determining, by the decision agent corresponding to the scene element function library, a candidate scene element function from the plurality of action functions based on the first description text; generating, by the decision agent corresponding to the scene element function library, a detection result based on the first description text and the candidate scene element function, the detection result indicating whether the candidate scene element function is accurate, and when the detection result indicates that the candidate scene element function is incorrect, the detection result further including an error reason; determining, when the detection result indicates that the candidate scene element function is accurate, the candidate scene element function as the first scene element function; and determining, by the decision agent when the detection result indicates that the candidate scene element function is incorrect, a next candidate scene element function based on the first description text and the error reason, until the detection result indicates that a currently obtained candidate scene element function is accurate, and determining the currently obtained candidate scene element function as the first scene element function.

The processing of the scene element agent includes a decision process and a self-check process. In the decision process, the scene element agent determines a candidate action function that is intelligently selected. In the self-check process, the scene element agent detects the candidate element function selected by this agent, to determine whether the selection result is accurate. If the result is accurate, the currently selected candidate element function is used as a final element function. If the result is inaccurate, the scene element agent needs to enter the decision process again, re-select a candidate element function with reference to the first description text and the error reason, and enter the self-check process again, to detect the candidate element function selected at this time, until the selected candidate element function successfully passes the self-check, and the candidate element function passing the self-check successfully is used as a final element function.

In some embodiments, the candidate element function is determined in the plurality of action functions by the decision agent corresponding to the scene element function library based on the first description text. This process involves an intelligent selection and self-check mechanism of the decision agent. First, the decision agent further analyzes the first description text, to extract key words and phrases related to scene elements. Then, in the scene element function library, the agent intelligently selects, according to these keywords and phrases, candidate element functions matching the keywords and the phrases. These candidate element functions are functions for controlling a scene element in an animation, and can add various visual and auditory effects to an animation scene.

In some embodiments, the decision agent performs self-check on the selected candidate element functions. The self-check process includes checking accuracy of the candidate element function, to ensure that the candidate element function can accurately reflect the scene element in the first description text. If the detection result indicates that the candidate element function is accurate, the agent determines the function as the first element function to generate the animation scene. If the detection result indicates that the candidate element function is incorrect, the agent records an error reason, re-enters the decision process, and re-selects a candidate element function with reference to the first description text and the error reason.

In some embodiments, the processing of the scene element agent includes a decision process and a self-check process. In the decision process, the agent determines a candidate action function that is intelligently selected. In the self-check process, the agent detects the candidate element function selected by this agent, to determine whether the selection result is accurate. If the result is accurate, the currently selected candidate element function is used as a final element function. If the result is inaccurate, the scene element agent needs to enter the decision process again, re-select a candidate element function with reference to the first description text and the error reason, and enter the self-check process again, to detect the candidate element function selected at this time, until the selected candidate element function successfully passes the self-check, and the candidate element function passing the self-check successfully is used as a final element function. By means of an iterative process of decision and self-check, the scene element agent can ensure that a finally selected element function is accurate, thereby providing high-quality guarantee for generation of the animation scene. This process shows how the agent ensures generation quality and accuracy of the animation scene by using the intelligent selection and self-check mechanisms.

As an example, it is assumed that there is animation production software. A user hopes to generate an animation by using the software, to show a scene of a character running and avoiding obstacles in a forest. The first description text entered by the user is: “The character runs quickly in the forest and avoids trees and stones.” The virtual object identifier pre-selected by the user is “main character”. The decision agent first analyzes the text, to extract keywords “run”, “avoid”, “tree”, and “stone”. Then, the scene element function library is searched for element functions matching these keywords, such as the function “run quickly” matching “run”, the function “avoid obstacles” matching “avoid”, and the function “trees and stones” matching “tree” and “stone”. The agent selects the function “run quickly” as a candidate element function and detects the accuracy of the function. The detection result indicates that this function can accurately simulate the running action of the character. Therefore, this function is determined as the first element function. The agent selects the function “avoid obstacles” as a candidate element function and detects the accuracy of the function. The detection result indicates that this function can accurately simulate behaviors of the character for avoiding obstacles. Therefore, this function is determined as the first element function. The agent selects the function “trees and stones” as a candidate element function and detects the accuracy of the function. The detection result indicates that this function can accurately create an obstacle environment in the forest. Therefore, this function is determined as the first element function. The first element functions are invoked, and scene elements are added to “main character”. These elements jointly form an animation scene of a character running and avoiding obstacles in the forest, which is consistent with the description in the first description text of the user.

In some embodiments, after the decision agent determines a function according to a description text, the decision agent further performs self-check on the selected function, to detect whether a decision result thereof is accurate. If the decision result is incorrect, the decision agent re-determines a function according to the description text and a current error reason, until the currently determined function passes self-check. Therefore, by adding a self-check procedure, it can be effectively ensured that the decision agent selects a more accurate function, thereby ensuring adaptation of a subsequently generated animation to the description text.

Moreover, since the action function library and the scene element function library have a significant semantic gap in functionality, respective decision agents are configured for the action function library and the scene element function library respectively. The two decision agents can perform analysis for the corresponding function libraries. The two decision agents execute respective decision tasks independently, which helps improve the accuracy of decision.

For ease of understanding, input and output in a decision process of the element decision agent are described below by using an example.

The input of the element decision agent is: Quantity of virtual objects: 3; Dynamic virtual objects: “kitten”, “puppy”, and “vehicle”; Static virtual objects: “vase”, “Christmas tree”, “stone carving”, and “sun”; Description text: “The sky darkens, a vehicle equipped with spotlights slowly drives toward a vase, and the vehicle is under the focus of a camera.”

The output of the element decision agent is: {Element function: “lighting functionality”; Function variables: “vehicle” and “high light intensity”}; {Element function: “switching camera”; Function variable: “vehicle”}.

In some embodiments, only an example where the first function library includes a scene element function library is used for description. Therefore, operation 304 needs to be performed.

In another embodiment, if the first function library does not include a scene element function library, operation 304 does not need to be performed.

By means of operation 303 and operation 304, the decision agent corresponding to the first function library determines the first function in the first function library based on the first description text.

In some embodiments, the decision agent determines a candidate function in the first function library based on the first description text. The decision agent generates a detection result based on the first description text and the candidate function, the detection result indicating whether the candidate function is accurate, and when the detection result indicates that the candidate function is incorrect, the detection result further including an error reason. When the detection result indicates that the candidate function is accurate, the candidate function is determined as the first function. The decision agent determines, when the detection result indicates that the candidate function is incorrect, a next candidate function based on the first description text and the error reason, until the detection result indicates that a currently obtained candidate function is accurate, and the currently obtained candidate function is determined as the first function.

In some embodiments, the decision agent first performs NLP on the first description text, to extract keywords and phrases related to an animation scene. For example, if the text describes “a character walking in the rain”, the extracted keywords may include “character”, “rain”, and “walk”. Based on a result of text analysis, the decision agent searches the first function library for functions matching the extracted keywords. These functions may be “character walking”, “rain effect”, and the like. The decision agent generates a detection result based on the first description text and the candidate function. The detection result indicates whether the candidate function is accurate. If the candidate function is inaccurate, the detection result further includes an error reason. For example, if the candidate function is “character running” instead of “character walking”, the error reason may be “action type mismatching”. If the detection result indicates that the candidate function is accurate, the decision agent determines the candidate function as the first function. If the detection result indicates that the candidate function is incorrect, the decision agent determines a next candidate function based on the first description text and the error reason. The process proceeds until the detection result indicates that the currently obtained candidate function is accurate. In this case, the agent determines the currently obtained candidate function as the first function.

305: The computer device generates, by a code generation agent, animation generation code corresponding to the first description text based on the first function, the animation generation code being configured for invoking the first function to generate an animation, and the code generation agent being configured to generate code.

After determining at least one first function needing to be used for generating an animation, the computer device provides the at least one first function to the code generation agent, and the code generation agent generates executable animation generation code according to the at least one first function. The code generation process can adaptively adapt to a change in the quantity of virtual objects during animation production, and the like, and is beneficial to performing dynamic modeling for a long time, thereby significantly reducing manual workload, and promoting automation of the animation production process.

In some embodiments, in operation 302, duration information is further determined, and operation 305 includes: generating, by the code generation agent, the animation generation code based on the first function and the duration information, the animation generation code being configured for invoking the first function to generate an animation that conforms to the duration information.

In some embodiments, the code generation agent receives a first function determined by the decision agent and duration information provided by a user. For example, the first function may be “character walking”, and the duration information may be “5 seconds”. The code generation agent generates a corresponding function invoking statement according to the first function. For example, if the first function is “character walking”, the generated function invoking statement may be ‘character.walk( )’. The code generation agent adds code according to the duration information to control the duration of the animation. This may involve setting a timer, an animation cycle, frame rate control, or the like. For example, if the duration information is “5 seconds”, the code generation agent may generate a timer, so that the function ‘character.walk( )’ stops being executed after 5 seconds. The code generation agent combines the function invoking statement and the duration control code into complete animation generation code. This may include initialization code, animation logic code, ending code, and the like. The code generation agent outputs the generated animation generation code for the computer device to execute. Execution of the code invokes the first function to generate an animation conforming to the duration information. The code generation agent can generate the animation generation code based on the first function and the duration information. This process shows how the code generation agent converts user requirements into a specific animation scene element by using function invocation, duration control, and code combination technologies.

As an example, it is assumed that there is animation production software. A user hopes to generate an animation by using the software, to show a scene of a character running and avoiding obstacles in a forest. The first description text entered by the user is: “The character runs quickly in the forest and avoids trees and stones.” The virtual object identifier pre-selected by the user is “main character”, and it is specified that the duration of the animation is 10 seconds. The decision agent analyzes the text, to extract keywords “run”, “avoid”, “tree”, and “stone”, and searches the scene element function library for a matching function. The determined first function may be “character running” and “avoid obstacles”. The code generation agent receives the first functions “character running” and “avoid obstacles” determined by the decision agent, and the duration information (10 seconds) specified by the user. The code generation agent generates a corresponding function invoking statement according to the first function. For example, the generated function invoking statement may be character.run( ) or character.avoidObstacles( ). The code generation agent adds code according to the duration information to control the duration of the animation. For example, the code generation agent may generate a timer, so that functions ‘character.run( )’ and character.avoidObstacles( ) stop being executed after 10 seconds. The code generation agent combines the function invoking statement and the duration control code into complete animation generation code. This may include initialization code, animation logic code, ending code, and the like. The code generation agent outputs the generated animation generation code for the computer device to execute. Execution of the code invokes the first functions “character running” and “avoid obstacles”, to generate an animation with a duration of 10 seconds, to display a scene in which a character runs in a forest and avoids obstacles.

In this way, the code generation agent further understands the first function and the duration information by using an NLP technology, and automatically generates corresponding animation generation code. Such a code generation process not only improves automation of animation production, but also reduces time and energy for manually writing code. In addition, the code generation agent can further automatically adjust the duration of the animation according to the duration information, to ensure that the generated animation meets user requirements and expectations. Through this method, the computer device can quickly generate animation scenes meeting user requirements, reduce the workload of manual adjustment and optimization, and improve the efficiency and quality of animation production.

In some embodiments, operation 305 includes: generating, by the code generation agent, the animation generation code based on the first function and at least one virtual object identifier, the virtual object identifier indicating a virtual object appearing in an animation, and the animation generation code being configured for invoking the first function to generate an animation including the virtual object.

The at least one virtual object identifier is a pre-selected virtual object identifier. The virtual object indicated by the virtual object identifier is a virtual object that a user expects to appear in a to-be-generated animation.

In some embodiments, the code generation agent generates animation generation code based on the first function and at least one virtual object identifier. The code generation agent first identifies a virtual object identifier pre-selected by a user. These identifiers indicate virtual objects that the user expects to appear in a to-be-generated animation. For example, the virtual object identifier may be “main character”, “supporting character”, or the like. The code generation agent determines a to-be-generated animation content based on the first function and the virtual object identifier. For example, if the first function is “character running” and the virtual object identifier is “main character”, the code generation agent generates an animation of main character running. The code generation agent generates corresponding animation generation code according to the first function and the virtual object identifier. The computer device executes the generated animation generation code, invokes the first function, and generates an animation including a virtual object. The animation presents behaviors and actions of the virtual object in the animation. The code generation agent can generate the animation generation code based on the first function and the at least one virtual object identifier. This process shows how the code generation agent converts user requirements into a specific animation scene element by using the virtual object identifier, the first function, and a code generation technology.

In some embodiments, the code generation agent generates executable animation generation code according to an intelligently selected function and a determined virtual object, to ensure that a generated animation includes a specified virtual object, thereby improving the operability of animation generation.

In some embodiments, operation 305 includes: generating, by the code generation agent, the animation generation code based on the first function, at least one virtual object identifier, and duration information, the virtual object identifier indicating a virtual object appearing in an animation, the animation generation code being configured for invoking the first function to generate an animation including the virtual object, and duration of the animation meeting the duration information.

In some embodiments, the code generation agent first parses an input provided by a user, including the first function, the virtual object identifier, and the duration information. For example, the first function may be “character dancing”, the virtual object identifier is “main character”, and the duration information is “30 seconds”. The code generation agent generates a corresponding function invoking statement according to the first function and the virtual object identifier. For example, the generated function invoking statement may be main_character.dance( ). The code generation agent adds code according to the duration information to control the duration of the animation. This may involve setting a timer, an animation cycle, frame rate control, or the like. For example, if the duration information is “30 seconds”, the code generation agent may generate a timer, so that the function ‘main_character.dance( )’ stops being executed after 30 seconds. The code generation agent combines the function invoking statement and the duration control code into complete animation generation code. This may include initialization code, animation logic code, ending code, and the like. The code generation agent outputs the generated animation generation code for the computer device to execute. Execution of the code invokes the first function “character dancing”, to generate an animation with a duration of 30 seconds, to display a scene in which a character dances. The code generation agent can generate the animation generation code based on the first function, the at least one virtual object identifier, and the duration information. This process shows how the code generation agent converts user requirements into a specific animation scene element by using function invocation, duration control, and code combination technologies.

306: The computer device executes the animation generation code corresponding to the first description text, to obtain a first animation, content of the first animation conforming to content described by the first description text.

In some embodiments, an animation production application runs in the computer device. The plurality of function libraries are predefined in the animation production application. The animation generation code is executable code in the animation production application. The computer device executes the animation generation code in the animation production application, to render a 3D animation, so as to obtain the first animation. For example, the animation production application is Blender or the like.

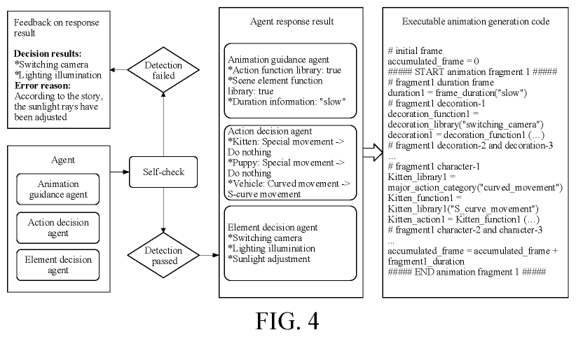

FIG. 4 is a schematic diagram of an animation generation method according to one or more embodiments. As shown in FIG. 4, an animation guidance agent, an action decision agent, and an element decision agent make a response based on a description text, to obtain a response result of each agent. Moreover, the animation guidance agent, the action decision agent, and the element decision agent can perform self-check on the respective response results until a response result indicating that the self-check succeeds is obtained. As shown in FIG. 4, the response result of the animation guidance agent indicates that an action function library and a scene element function library need to be invoked, and duration information is “slow”. The response result of the action decision agent indicates an action function that needs to be invoked for controlling a kitten, a puppy, or a vehicle. The response result of the element decision agent indicates an element function that needs to be invoked for adding a scene element to an animation. Further, according to the response results of the three agents, the duration information as well as the action function and the element function that need to be invoked are converted into executable animation generation code, to obtain a 3D rendered animation by executing the animation generation code.

According to the method provided in some embodiments, when an animation needs to be generated, only a description text for describing the animation needs to be provided. An animation guidance agent intelligently predicts, according to the description text, a specific function library to be used to generate the animation. Then, a decision agent corresponding to the function library intelligently predicts, according to the description text, a specific function in the function library to be used to generate the animation. Then, a code generation agent intelligently generates, according to the selected function, executable animation generation code. The animation generation code is configured for invoking the intelligently selected function to generate the animation. Therefore, a corresponding animation may be obtained by executing the animation generation code. Since the function used for generating the animation is intelligently selected according to the description text, the animation generated by invoking the function conforms to content described by the description text, so that the matching animation is automatically generated based on the description text. The animation production process is more intelligent and automatic, thereby improving the animation generation efficiency.

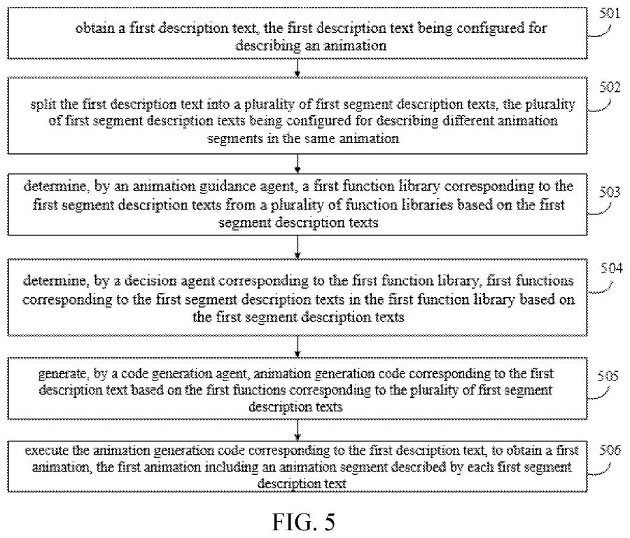

Based on the foregoing embodiments, the description text may further be divided into a plurality of segment description texts. An animation is generated shot by shot in units of segment description texts. For the detailed process, refer to the embodiment of FIG. 5 below. FIG. 5 is a flowchart of another animation generation method according to one or more embodiments. One or more embodiments according to FIG. 5 may be performed by a computer device. Referring to FIG. 5, the method includes:

501: A computer device obtains a first description text, the first description text being configured for describing an animation.

Operation 501 is similar to operation 201, and is not repeatedly described herein.

502: The computer device splits the first description text into a plurality of first segment description texts, the plurality of first segment description texts being configured for describing different animation segments in the same animation.

The first description text includes the plurality of first segment description texts. To be specific, the plurality of first segment description texts can form the first description text. The first description text describes an entire animation, and the first segment description texts describe different animation segments in the animation.

In some embodiments, the computer device splits the description text into a plurality of first segment description texts based on punctuation marks in the description text. For example, the description text is split according to periods, and the description text between two periods is taken as one first segment description text.

503: The computer device determines, by an animation guidance agent, a first function library corresponding to the first segment description texts from a plurality of function libraries based on the first segment description texts.

504: The computer device determines, by a decision agent corresponding to the first function library, first functions corresponding to the first segment description texts in the first function library based on the first segment description texts.

The process of determining the first function in operation 503 to operation 504 is similar to the process of determining the first function in operation 302 to operation 304, and is not repeatedly described herein.

For each first segment description text, the computer device performs the foregoing operations 503 to 504, to obtain a first function corresponding to each first segment description text.

505: The computer device generates, by a code generation agent, animation generation code corresponding to the first description text based on the first functions corresponding to the plurality of first segment description texts.

In some embodiments, the computer device provides the first functions corresponding to the plurality of first segment description texts to the code generation agent, and the code generation agent directly generates animation generation code corresponding to the entire first description text. The animation generation code corresponding to the first description text includes animation generation code corresponding to each first segment description text. The animation generation code corresponding to the first segment description text is configured for generating an animation segment described by the first segment description text.

In addition, the process of operation 505 is similar to that of operation 305, and is not repeatedly described herein.

506: The computer device executes the animation generation code corresponding to the first description text, to obtain a first animation, the first animation including an animation segment described by each first segment description text.

The process of operation 506 is similar to that of operation 306, and is not repeatedly described herein.

In some embodiments, the computer device first obtains a first description text provided by a user. The text is configured for describing content of the entire animation. For example, the first description text may be: “A character runs in a forest, then encounters a friendly animal, and finally goes on an adventure together.” The computer device splits the first description text into a plurality of first segment description texts. Each segment description text corresponds to a different animation segment in the animation. For example, the split segment description texts may be: “A character runs in a forest”, “encounters a friendly animal”, and “goes on an adventure together”. The computer device determines, by an animation guidance agent, a corresponding first function library from a plurality of function libraries based on each first segment description text. For example, for the segment description text “A character runs in a forest”, the animation guidance agent may determine a “character action function library” and a “scene function library”. The computer device determines, by a decision agent corresponding to the first function library, a corresponding first function in the first function library based on each first segment description text. For example, for the segment description text “A character runs in a forest”, the decision agent may determine a “character running function library” and a “forest scene function”. The computer device generates, by a code generation agent, animation generation code corresponding to the first description text based on the first functions corresponding to the plurality of first segment description texts. The computer device can generate corresponding animation generation code based on the first description text. This process shows how the computer device converts user requirements into a specific animation scene element by using text splitting, the animation guidance agent, the decision agent, and the code generation agent.

As an example, it is assumed that there is animation production software. A user hopes to generate an animation by using the software, to show a scene in which a character runs in a forest, then encounters a friendly animal, and finally goes on an adventure together. A first description text entered by the user is: “A character runs in a forest, then encounters a friendly animal, and finally goes on an adventure together.” The computer device first obtains the first description text provided by the user: “A character runs in a forest, then encounters a friendly animal, and finally goes on an adventure together.” The computer device splits the first description text into a plurality of first segment description texts. Each segment description text corresponds to a different animation segment in the animation. The split segment description texts may be: “A character runs in a forest”, “encounters a friendly animal”, and “goes on an adventure together”. The computer device determines, by an animation guidance agent, a corresponding first function library from a plurality of function libraries based on each first segment description text. For example, for the segment description text “A character runs in a forest”, the animation guidance agent may determine a “character action function library” and a “scene function library”. The computer device determines, by a decision agent corresponding to the first function library, a corresponding first function in the first function library based on each first segment description text. For example, for the segment description text “A character runs in a forest”, the decision agent may determine a “character running function library” and a “forest scene function”. The computer device generates, by a code generation agent, animation generation code corresponding to the first description text based on the first functions corresponding to the plurality of first segment description texts. The computer device executes the generated animation generation code, invokes corresponding functions, and generates and plays an animation. This animation presents a scene in which a character runs in the forest, then encounters a friendly animal, and goes on an adventure together, and is consistent with the description in the first description text of the user.

The embodiments of the disclosure are described by using only an example in which the animation generation code corresponding to the first description text is directly generated based on the first functions corresponding to the plurality of first segment description texts. In another embodiment, in operation 505, the computer device may further generate, based on a first function corresponding to each first segment description text, animation generation code corresponding to each first segment description text. Further, in operation 506, the computer device executes the animation generation code corresponding to the plurality of first segment description texts, to obtain a first animation. In some embodiments, in operation 506, the computer device executes the animation generation code corresponding to each first segment description text, to obtain an animation segment corresponding to each first segment description text, and splices the plurality of obtained animation segments, to obtain the first animation.

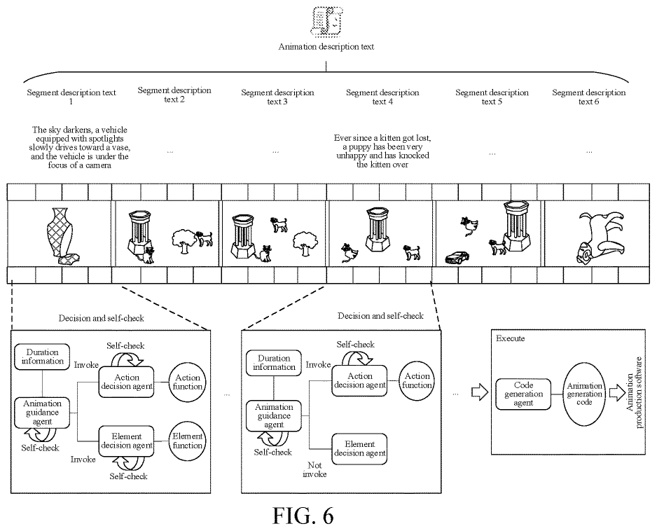

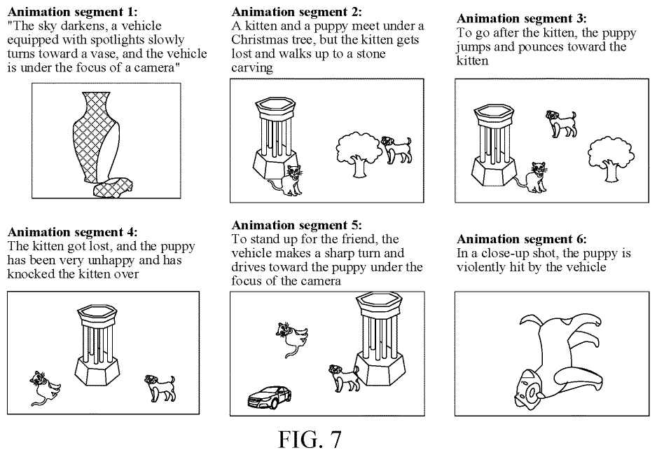

FIG. 6 is a schematic diagram of another animation generation method according to one or more embodiments. As shown in FIG. 6, a description text is divided into segment description text 1 to segment description text 6. Each segment description text is configured for describing an animation segment. Using segment description text 1 as an example, the animation guidance agent determines, by means of decision and self-check, duration information and an action decision agent and an element decision agent that need to be invoked. Further, the action decision agent and the element decision agent determine, by means of decision and self-check, an action function and an element function that need to be invoked. Using segment description text 2 as an example, the animation guidance agent determines, by means of decision and self-check, duration information and an action decision agent that needs to be invoked. Further, the action decision agent determines, by means of decision and self-check, an action function that needs to be invoked. Finally, the duration information, the action function, the element function, and the virtual object identifier that are determined for segment description text 1 to segment description text 6 are all provided to the code generation agent, and converted into executable animation generation code by the code generation agent. Further, an animation including a plurality of animation segments may be obtained by executing the animation generation code in animation production software. FIG. 7 is a schematic result diagram of an animation generation method according to one or more embodiments. As shown in FIG. 7, according to a processing procedure in FIG. 6, an animation including animation segment 1 to animation segment 6 may be finally obtained.

According to the method provided in some embodiments, when an animation needs to be generated, only a description text for describing the animation needs to be provided. An animation guidance agent intelligently predicts, according to the description text, a specific function library to be used to generate the animation. Then, a decision agent corresponding to the function library intelligently predicts, according to the description text, a specific function in the function library to be used to generate the animation. Then, a code generation agent intelligently generates, according to the selected function, executable animation generation code. The animation generation code is configured for invoking the intelligently selected function to generate the animation. Therefore, a corresponding animation may be obtained by executing the animation generation code. Since the function used for generating the animation is intelligently selected according to the description text, the animation generated by invoking the function conforms to content described by the description text, so that the matching animation is automatically generated based on the description text. The animation production process is more intelligent and automatic, thereby improving the animation generation efficiency.

Moreover, the description text is divided into a plurality of segment description texts, animation generation code corresponding to each segment description text is determined in units of the segment description texts, and each segment description text can correspondingly generate an animation segment. Splitting into the segment description texts is equivalent to processing shot by shot. This helps each agent fully understand the description text, thereby improving the accuracy of animation generation.

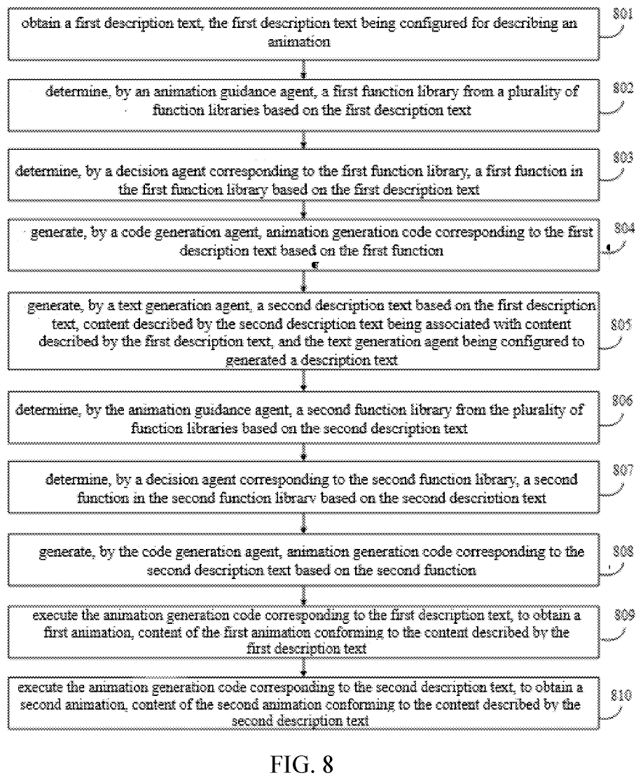

Based on the foregoing embodiments, the first description text may further be continued by using the text generation agent, to obtain a second description text associated therewith, and a second animation described in the second description text is generated, which is equivalent to expanding the generated animation content. For a detailed process, refer to the embodiment of FIG. 8 below.

FIG. 8 is a flowchart of another animation generation method according to one or more embodiments. One or more embodiments according to FIG. 8 may be performed by a computer device. Referring to FIG. 8, the method includes:

801: A computer device obtains a first description text, the first description text being configured for describing an animation.

802: The computer device determines, by an animation guidance agent, a first function library from a plurality of function libraries based on the first description text.

803: The computer device determines, by a decision agent corresponding to the first function library, a first function in the first function library based on the first description text.

804: The computer device generates, by a code generation agent, animation generation code corresponding to the first description text based on the first function.

The process of operation 801 to operation 804 is similar to that of operation 301 to operation 305, and is not repeatedly described herein.

805: The computer device generates, by a text generation agent, a second description text based on the first description text, content described by the second description text being associated with content described by the first description text, and the text generation agent being configured to generate a description text.

In some embodiments, the computer device first obtains a first description text provided by a user. The text is configured for describing content of the entire animation. For example, the first description text may be: “A character runs in a forest, then encounters a friendly animal, and finally goes on an adventure together.” The computer device determines, by an animation guidance agent, a corresponding first function library from a plurality of function libraries based on the first description text. For example, the animation guidance agent may determine a “character action function library”, a “scene function library”, and an “animal interaction function library”. The computer device determines, by a decision agent corresponding to the first function library, a corresponding first function in the first function library based on the first description text. For example, the decision agent may determine a “character running function”, a “forest scene function”, and an “animal interaction function”. The computer device generates, by the code generation agent, animation generation code corresponding to the first description text based on a plurality of first functions. The computer device generates, by the text generation agent, a second description text based on the first description text. Content described by the second description text is associated with content described by the first description text, and may include a further description of an animation scene, inner thoughts of a character, or other relevant plots. For example, the second description text may be: “In a dense forest, sunlight filters through the leaves and falls on a running character. He feels a sense of relief and freedom, as if the whole world is making way for him. Suddenly, he hears a soft cry, and a friendly deer appears in front of him. He stops and looks into the deer's eyes, and a warm feeling surges in his heart. They start to adventure together, traveling through the forest and exploring the unknown world.” The computer device executes the generated animation generation code, invokes corresponding functions, and generates and plays an animation. This animation presents a scene in which a character runs in the forest, then encounters a friendly animal, and goes on an adventure together, and is consistent with the description in the first description text of the user. Meanwhile, the second description text provides richer backgrounds and emotional colors for the animation, thereby enhancing watching experience of a user.

The computer device provides the first description text to the text generation agent, and the text generation agent may generate, according to the first description text, the second description text associated therewith. The text generation agent is configured to generate another description text associated with any description text. In some embodiments, the text generation agent belongs to an LLM.

In some embodiments, a narrative expansion function is provided. The text generation agent expands, based on the first description text, a second description text associated therewith. Content described by the second description text is consistent with and associated with content described by the first description text, so as to create a continuation animation based on the expanded description text.

In some embodiments, the computer device obtains condition information. The condition information indicates a condition that needs to be met by the generated description text. The computer device generates, by the text generation agent, a second description text based on the first description text and the condition information, where content described by the second description text is associated with the content described by the first description text, and the second description text meets the condition information.

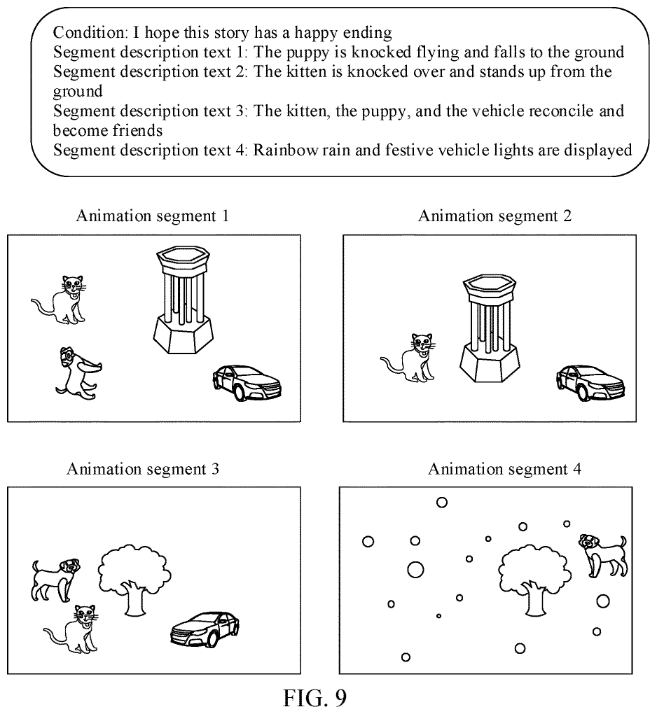

FIG. 9 is a schematic diagram of another animation generation method according to one or more embodiments. The input of a text generation agent is a first description text and condition information. For example, the condition information is “I hope this story has a happy ending”, and the condition information indicates a condition met by the second description text. The output of the text generation agent is a second description text that meets the condition information. As shown in FIG. 9, the second description text includes segment description text 1 to segment description text 4. Each segment description text is configured for describing an animation segment.

806: The computer device determines, by the animation guidance agent, a second function library from the plurality of function libraries based on the second description text.

807: The computer device determines, by a decision agent corresponding to the second function library, a second function in the second function library based on the second description text.

808: The computer device generates, by the code generation agent, animation generation code corresponding to the second description text based on the second function.

The process of operation 806 to operation 806 is similar to that of operation 302 to operation 305, and is not repeatedly described herein.

809: The computer device executes the animation generation code corresponding to the first description text, to obtain a first animation, content of the first animation conforming to the content described by the first description text.

810: The computer device executes the animation generation code corresponding to the second description text, to obtain a second animation, content of the second animation conforming to the content described by the second description text.

In some embodiments, the computer device determines, by the animation guidance agent, a second function library from the plurality of function libraries based on the second description text. Then, the computer device determines, by a decision agent corresponding to the second function library, a second function in the second function library based on the second description text. Next, the computer device generates, by the code generation agent, animation generation code corresponding to the second description text based on the second function. Finally, the computer device executes the animation generation code corresponding to the first description text, to obtain a first animation, content of the first animation conforming to the content described by the first description text. The computer device executes the animation generation code corresponding to the second description text, to obtain a second animation, content of the second animation conforming to the content described by the second description text.

As an example, in the field of education, the computer device may be configured to produce an education animation to help students understand complex concepts better. For example, it is assumed that there is education software. The education software needs to generate corresponding animations according to different teaching content. The computer device determines, by the animation guidance agent, a second function library from the plurality of function libraries based on the second description text. The description text may be a description about a cell division process in biology. The animation guidance agent analyzes the description text, understands key concepts and processes therein, and then searches a plurality of function libraries for an animation function library related to cell division. The computer device determines, by a decision agent corresponding to the second function library, a second function in the second function library based on the second description text. The decision agent further analyzes the description text, to determine specific animation functions that need to represent different stages of cell division, such as an interval, an early stage, an intermediate stage, a late stage, and an end stage. Based on these requirements, the decision agent determines a specific animation function in the selected function library. The computer device generates, by the code generation agent, animation generation code corresponding to the second description text based on the second function. The code generation agent generates corresponding code according to the selected animation function. The code can invoke these functions to create an animation of cell division. The computer device executes the animation generation code corresponding to the first description text, to obtain a first animation, content of the first animation conforming to the content described by the first description text. The first description text may be a description about force in physics. The computer device executes the code to generate an animation that presents the concept of force, and animation content conforms to the description text. The computer device executes the animation generation code corresponding to the second description text, to obtain a second animation, content of the second animation conforming to the content described by the second description text. The computer device executes the previously generated cell division animation code, to generate an animation presenting a process of cell division, and animation content conforms to the description text. The education software may automatically generate corresponding animations according to different teaching content, to help students understand complex scientific concepts more intuitively.

Since content described by the second description text is associated with content described by the first description text, the first animation includes the content described by the first description text, and the second animation includes the content described by the second description text, the content of the second animation is associated with the content of the first animation. The second animation is subsequent to the first animation. Therefore, the first animation and the second animation may be combined into a complete animation.

In the solution provided in some embodiments, in addition to automatically generating the first animation by using the first description text provided by the user, the text generation agent may further perform continuation on the first description text, to obtain a second description text associated therewith, and then automatically generate a second animation by using the second description text. Therefore, the described content may be intelligently diverged based on only a description text provided by the user to generate a corresponding animation, thereby further improving the intelligence of animation generation, making the generated animation richer and interesting, and bringing additional surprise to the user.

The methods in the foregoing embodiments may be implemented by an LLM. It is difficult for the LLM to directly generate executable animation generation code according to the description text. Then, the LLM may be instructed in a programmatic modeling manner to respectively perform functions at different stages, so that the LLM can make a decision at a cognitive level. Therefore, based on the LLM, the animation guidance agent, the action decision agent, the element decision agent, the code generation agent, and the text generation agent are separately introduced. Moreover, a plurality of function libraries for generating animations are predefined. Further, a learning capability of the LLM is adopted, so that each agent learns a responsible functionality thereof.

For ease of description, the following definitions are described first.

L (function library) describes an objective and functionality of a predefined function library.

F (function) describes the functionality of a function in the predefined function library.

V (function variable) explains a function variable.

I (learning example) provides input and output, to demonstrate how to use the provided input to perform reasoning output. The learning example is presented in a form of context learning.

The following describes a learning process of the animation guidance agent, the decision agents (the action decision agent and the element decision agent), the code generation agent, and the text generation agent.

Animation Guidance Agent: The animation guidance agent belongs to an LLM. Before the determining, by an animation guidance agent, a first function library from a plurality of function libraries based on a first description text, the method further includes: inputting first learning information to the animation guidance agent, the first learning information being configured for instructing the animation guidance agent to learn to predict a function library corresponding to any description text.

The first learning information includes introduction information of the plurality of function libraries and a first learning example, the first learning example includes a sample description text and a sample function library corresponding to the sample description text, and the sample function library belongs to the plurality of function libraries. The animation guidance agent learns the functionality of each function library by using introduction information of the function library. Further, how to determine the corresponding sample function library according to the sample description text in the first learning example is learned with reference to understanding of the functionality of the function library. In addition, the first learning information further includes first prompt information. The first prompt information is configured for instructing the animation guidance agent how to perform learning.

For ease of understanding, the first learning information is described below by using an example.
(1) First prompt information: Assuming that a user is an animation guidance expert of a 3D animation, the user may determine, according to a description text, which function library is used to create the 3D animation. The user is provided with two function libraries: an action function library <Laction> and a scene element function library <Ldecoration>, which are described in detail. The user is enabled to understand the functionality thereof to facilitate analysis. Furthermore, the user needs to provide animation duration information. The user may select four different types of duration information, including “fast”, “moderate”, “slow”, and “emphasized”. In addition, a learning example <Idirector> is further provided to teach the user how to reply.
(2) Introduction information of the action function library <Laction> and the scene element function library <Ldecoration>.
(3) Input in the first learning example: a sample description text.
(4) Output in the first learning example: a sample function library and sample duration information.

In some embodiments, the animation guidance agent belongs to an LLM and the LLM has a learning capability. Therefore, only the first learning information needs to be provided for the animation guidance agent, and the animation guidance agent may learn how to predict the function library by using the first learning information. Parameters of the animation guidance agent do not need to be adjusted. The operation is convenient and simple, facilitating improving learning efficiency.

Decision Agent: The decision agent belongs to an LLM. Before the determining, by using a decision agent corresponding to the first function library based on the first description text, a first function in the first function library, the method further includes: inputting second learning information to the decision agent corresponding to the first function library, the second learning information being configured for instructing the decision agent corresponding to the first function library to learn to predict a function corresponding to any description text.

The second learning information includes introduction information of each function in the first function library and a second learning example, the second learning example includes a sample description text and a sample function corresponding to the sample description text, and the sample function belongs to the first function library. The decision agent learns the functionality of each function by using introduction information of each function in the function library. Further, how to determine the corresponding sample function according to the sample description text in the second learning example is learned with reference to understanding of the functionality of the function. In addition, the second learning information further includes second prompt information. The second prompt information is configured for instructing the decision agent how to perform learning.

In some embodiments, the decision agent includes an action decision agent. Action functions in the action function library have corresponding action categories. Then, C (action category) is further defined: which describes the functionality of each action category in the action function library. For ease of understanding, the second learning information of the action decision agent is described below by using an example.
(1) Second prompt information: Assuming that a user is an action decision expert of a 3D animation, the user may determine, according to a description text, which action functions in an action function library are used to create the 3D animation. A detailed description of an action function library <Laction>, an action category <Caction> included in the action function library <Laction>, and an action function <Faction> included in each action category <Caction> are provided. The user is required to learn how to use an action function <Vaction> with a variable explanation. In addition, a learning example <Iaction> is further provided to teach the user how to reply.
(2) Introduction information of the action function library <Laction> and the action category <Caction> and the action function <Faction> included therein.
(3) Input in the second learning example: a sample description text.
(4) Output in the second learning example: a sample action category and a sample action function.

In some embodiments, the decision agent includes an element decision agent. For ease of understanding, the second learning information of the element decision agent is described below by using an example.
(1) Second prompt information: Assuming that a user is very good at decorating a 3D animation, the user may determine, according to a description text, which scene elements in a scene element function library are used to decorate the 3D animation. A scene element function library <Ldecoration>, and an element function <Fdecoration> included in the scene element function library <Ldecoration> are described in detail. The user is required to learn how to use an element function <Vdecoration> with a variable explanation. In addition, a learning example <Idecoration> is further provided to teach the user how to reply.
(2) Introduction information of the scene element function library <Ldecoration> and the element function <Fdecoration> included therein.
(3) Input in the second learning example: a sample description text.
(4) Output in the second learning example: a sample element function.

In some embodiments, the decision agent belongs to an LLM and the LLM has a learning capability. Therefore, only the second learning information needs to be provided for the decision agent, and the decision agent may learn how to predict the function by using the second learning information. Parameters of the decision agent do not need to be adjusted. The operation is convenient and simple, facilitating improving learning efficiency.

Code Generation Agent: The code generation agent belongs to an LLM. Before the generating, by a code generation agent, animation generation code corresponding to the first description text based on the first function, the method further includes: inputting third learning information to the code generation agent, the third learning information being configured for instructing the code generation agent to learn to predict animation generation code corresponding to any description text.

The third learning information includes a third learning example, and the third learning example includes a sample function corresponding to sample description text and sample animation generation code. The code generation agent learns how to generate the sample animation generation code according to the sample function in the third learning example. In addition, the third learning information further includes third prompt information. The third prompt information is configured for instructing the code generation agent how to perform learning.

In some embodiments, the code generation agent belongs to an LLM and the LLM has a learning capability. Therefore, only the third learning information needs to be provided for the code generation agent, and the code generation agent may learn how to generate executable animation generation code by using the third learning information. Parameters of the code generation agent do not need to be adjusted. The operation is convenient and simple, facilitating improving learning efficiency.

Text Generation Agent: The text generation agent belongs to an LLM. Before the generating, by a text generation agent, a second description text based on the first description text, the method further includes: inputting fourth learning information to the text generation agent, the fourth learning information being configured for instructing the text generation agent to learn to predict another description text associated with any description text.

The fourth learning information includes introduction information of the plurality of function libraries and a fourth learning example, the fourth learning example includes a first sample description text and a second sample description text, and content described by the first sample description text is associated with content described by the second sample description text. The text generation agent learns the functionality of each function library by using introduction information of the function library. Further, how to generate the second sample description text according to the first sample description text in the fourth learning example is learned with reference to understanding of the functionality of the function library. In addition, the fourth learning information further includes fourth prompt information. The fourth prompt information is configured for instructing the text generation agent how to perform learning.

For ease of understanding, the fourth learning information is described below by using an example.
(1) Fourth prompt information: Imagining that a user is very good at creating a 3D animation, the user may continue to create a new story based on an existing story. The new story created by the user needs to be implemented by an action function library <Laction> and a scene element function library <Ldecoration>, and the action function library <Laction> and the scene element function library <Ldecoration> are described in detail. In addition, a learning example <Icontinuation> is further provided to teach the user how to reply.
(2) Introduction information of the action function library <Laction> and the scene element function library <Ldecoration>.
(3) Input in the fourth learning example: a first sample description text and condition information.
(4) Output in the fourth learning example: a second sample description text.

In some embodiments, the text generation agent belongs to an LLM and the LLM has a learning capability. Therefore, only the fourth learning information needs to be provided for the text generation agent, and the text generation agent may learn how to generate a description text by using the fourth learning information. Parameters of the text generation agent do not need to be adjusted. The operation is convenient and simple, facilitating improving learning efficiency.

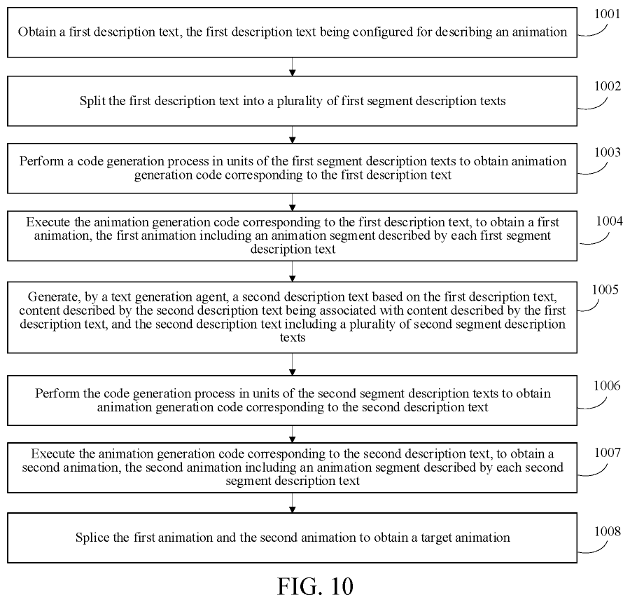

FIG. 10 is a flowchart of another animation generation method according to one or more embodiments. As shown in FIG. 10, the method includes the following operations.

1001: Obtain a first description text, the first description text being configured for describing an animation.

1002: Split the first description text into a plurality of first segment description texts.

1003: Perform a code generation process in units of the first segment description texts to obtain animation generation code corresponding to the first description text.

The code generation process includes the following operations:
(1) Determine, by an animation guidance agent, a first function library and duration information from a plurality of function libraries based on the first segment description texts.
(2) Determine, by a decision agent corresponding to an action function library, a first action function corresponding to each virtual object identifier in a plurality of action functions based on the first segment description texts and at least one virtual object identifier when the first function library includes the action function library.
(3) Determine, by a decision agent corresponding to a scene element function library, a first element function from a plurality of element functions based on the first segment description texts when the first function library includes the scene element function library.
(4) Generate, by a code generation agent, animation generation code corresponding to the first description text based on the at least one virtual object identifier, the first action function, the first element function, and the duration information that correspond to the plurality of first segment description texts.

1004: Execute the animation generation code corresponding to the first description text, to obtain a first animation, the first animation including an animation segment described by each first segment description text.

1005: Generate, by a text generation agent, a second description text based on the first description text, content described by the second description text being associated with content described by the first description text, and the second description text including a plurality of second segment description texts.

1006: Perform the code generation process in units of the second segment description texts to obtain animation generation code corresponding to the second description text.

The code generation process includes the following operations:
(1) Determine, by the animation guidance agent, a second function library and duration information from the plurality of function libraries based on the second segment description texts.
(2) Determine, by a decision agent corresponding to an action function library, a second action function corresponding to each virtual object identifier in a plurality of action functions based on the second segment description texts and at least one virtual object identifier when the second function library includes the action function library.
(3) Determine, by a decision agent corresponding to a scene element function library, a second element function from a plurality of element functions based on the second segment description texts when the second function library includes the scene element function library.
(4) Generate, by a code generation agent, animation generation code corresponding to the second description text based on the at least one virtual object identifier, the second action function, the second element function, and the duration information that correspond to the plurality of second segment description texts.

1007: Execute the animation generation code corresponding to the second description text, to obtain a second animation, the second animation including an animation segment described by each second segment description text.

1008: Splice the first animation and the second animation to obtain a target animation.

The animation guidance agent, the decision agents (the action decision agent and the element decision agent), the code generation agent, and the text generation agent involved in some embodiments may be considered as a whole, and are collectively referred to as an animation generation agent (Animate3D-Agent). This is a novel LLM-Agent framework for using an LLM during exploration of 3D animation production.

The method provided in some embodiments provides a brand new viewing angle for animation creation, and effectively solves challenges in 3D animation production, including the action choreography of a plurality of virtual objects and the configuration of various scene elements under a given narrative context. In addition, the description text is split into a plurality of segment description texts for processing, so as to ensure that a plurality of generated animation segments comply with a predetermined story timeline, thereby maintaining narrative consistency and scene consistency in the entire animation. Moreover, the Animate3D-Agent further implements a capability of extending animation content, and the extended content keeps context consistency with original content, thereby possibly enhancing a 3D animation representation capability.

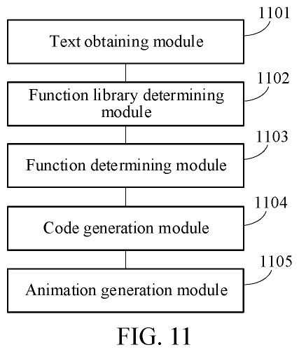

FIG. 11 is a schematic structural diagram of an animation generation apparatus according to one or more embodiments. Referring to FIG. 11, the apparatus includes:
a text obtaining module 1101, configured to obtain a first description text, the first description text being configured for describing an animation;
a function library determining module 1102, configured to determine, by an animation guidance agent, a first function library from a plurality of function libraries based on the first description text, functions in the function libraries being configured for generating an animation, each function library having a corresponding decision agent, the animation guidance agent being configured to determine the function libraries, and the decision agent being configured to determine a function;
a function determining module 1103, configured to determine, by a decision agent corresponding to the first function library, the first function in the first function library based on the first description text;
a code generation module 1104, configured to generate, by a code generation agent, animation generation code corresponding to the first description text based on the first function, the animation generation code being configured for invoking the first function to generate an animation, and the code generation agent being configured to generate code; and
an animation generation module 1105, configured to execute the animation generation code corresponding to the first description text, to obtain a first animation, content of the first animation conforming to content described by the first description text.

According to the animation generation apparatus provided in some embodiments, when an animation needs to be generated, only a description text for describing the animation needs to be provided. An animation guidance agent intelligently predicts, according to the description text, a specific function library to be used to generate the animation. Then, a decision agent corresponding to the function library intelligently predicts, according to the description text, a specific function in the function library to be used to generate the animation. Then, a code generation agent intelligently generates, according to the selected function, executable animation generation code. The animation generation code is configured for invoking the intelligently selected function to generate the animation. Therefore, a corresponding animation may be obtained by executing the animation generation code. Since the function used for generating the animation is intelligently selected according to the description text, the animation generated by invoking the function conforms to content described by the description text, so that the matching animation is automatically generated based on the description text. The animation production process is more intelligent and automatic, thereby improving the animation generation efficiency.

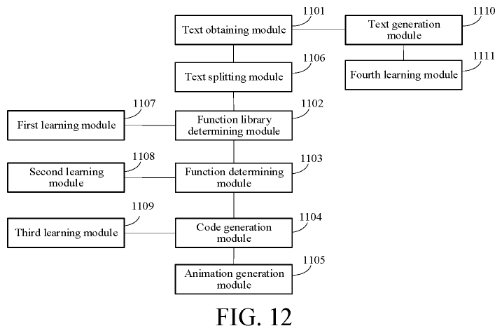

In some embodiments, referring to FIG. 12, the plurality of function libraries include an action function library, and the action function library includes a plurality of action functions for controlling an action of a virtual object in an animation. The function determining module 1103 is configured to:
determine, by a decision agent corresponding to the action function library, a first action function from the plurality of action functions based on the first description text when the first function library includes the action function library.

In some embodiments, referring to FIG. 12, the action functions correspond to respective action categories, one action function belongs to one action category, and one action category includes at least one action function. The function determining module 1103 is configured to:
determine, by the decision agent corresponding to the action function library, a target action category from the plurality of action categories based on the first description text; and
determine, by the decision agent corresponding to the action function library, the first action function from action functions belonging to the target action category based on the first description text.

In some embodiments, referring to FIG. 12, the function determining module 1103 is configured to:
determine, by the decision agent corresponding to the action function library, a first action function corresponding to at least one virtual object identifier based on the first description text and the at least one virtual object identifier, the virtual object identifier indicating a virtual object appearing in an animation, and the first action function corresponding to the virtual object identifier being configured for controlling an action of the virtual object.

In some embodiments, referring to FIG. 12, the plurality of function libraries include a scene element function library, and the scene element function library includes a plurality of element functions for controlling a scene element in an animation. The function determining module 1103 is configured to:
determine, by a decision agent corresponding to the scene element function library, a first element function from the plurality of element functions based on the first description text when the first function library includes the scene element function library.

In some embodiments, referring to FIG. 12, the function determining module 1103 is configured to:
determine, by the decision agent corresponding to the scene element function library, a first element function corresponding to at least one virtual object identifier based on the first description text and the at least one virtual object identifier, the virtual object identifier indicating a virtual object appearing in an animation, and the first element function corresponding to the virtual object identifier being configured for adding a scene element to the virtual object.

In some embodiments, referring to FIG. 12, the function library determining module 1102 is configured to determine, by the animation guidance agent, a first function library and duration information based on the first description text.

The code generation module 1104 is configured to generate, by the code generation agent, the animation generation code based on the first function and the duration information, the animation generation code being configured for invoking the first function to generate an animation that conforms to the duration information.

In some embodiments, referring to FIG. 12, the code generation module 1104 is configured to:
generate, by the code generation agent, the animation generation code based on the first function and at least one virtual object identifier, the virtual object identifier indicating a virtual object appearing in an animation, and the animation generation code being configured for invoking the first function to generate an animation including the virtual object.

In some embodiments, referring to FIG. 12, the apparatus further includes:
a text splitting module 1106, configured to split the first description text into a plurality of first segment description texts, the plurality of first segment description texts being configured for describing different animation segments in the same animation, where the animation guidance agent is configured to determine a first function library corresponding to each first segment description text, and the decision agent corresponding to the first function library is configured to determine a first function corresponding to each first segment description text; and
a code generation module 1104, configured to generate, by the code generation agent, the animation generation code corresponding to the first description text based on the first functions corresponding to the plurality of first segment description texts.

In some embodiments, referring to FIG. 12, the function library determining module 1102 is configured to:
determine, by the animation guidance agent, a candidate function library from the plurality of function libraries based on the first description text;
generate, by the animation guidance agent, a detection result based on the first description text and the candidate function library, the detection result indicating whether the candidate function library is accurate, and when the detection result indicates that the candidate function library is incorrect, the detection result further including an error reason;
determine, when the detection result indicates that the candidate function library is accurate, the candidate function library as the first function library; and
determine, by the animation guidance agent when the detection result indicates that the candidate function library is incorrect, a next candidate function library based on the first description text and the error reason, until the detection result indicates that a currently obtained candidate function library is accurate, and determine the currently obtained candidate function library as the first function library.

In some embodiments, referring to FIG. 12, the function determining module 1103 is configured to:
determine by the decision agent, a candidate function in the first function library based on the first description text;
generate, by the decision agent, a detection result based on the first description text and the candidate function, the detection result indicating whether the candidate function is accurate, and when the detection result indicates that the candidate function is incorrect, the detection result further including an error reason;
determine, when the detection result indicates that the candidate function is accurate, the candidate function as the first function; and
determine, by the decision agent when the detection result indicates that the candidate function is incorrect, a next candidate function based on the first description text and the error reason, until the detection result indicates that a currently obtained candidate function is accurate, and determine the currently obtained candidate function as the first function.

In some embodiments, referring to FIG. 12, the animation guidance agent belongs to an LLM. The apparatus further includes:
a first learning module 1107, configured to input first learning information to the animation guidance agent, the first learning information being configured for instructing the animation guidance agent to learn to predict a function library corresponding to any description text.

The first learning information includes introduction information of the plurality of function libraries and a first learning example, the first learning example includes a sample description text and a sample function library corresponding to the sample description text, and the sample function library belongs to the plurality of function libraries.

In some embodiments, referring to FIG. 12, the decision agent belongs to an LLM. The apparatus further includes:
a second learning module 1108, configured to input second learning information to the decision agent corresponding to the first function library, the second learning information being configured for instructing the decision agent corresponding to the first function library to learn to predict a function corresponding to any description text.

The second learning information includes introduction information of each function in the first function library and a second learning example, the second learning example includes a sample description text and a sample function corresponding to the sample description text, and the sample function belongs to the first function library.

In some embodiments, referring to FIG. 12, the code generation agent belongs to an LLM. The apparatus further includes:
a third learning module 1109, configured to input third learning information to the code generation agent, the third learning information being configured for instructing the code generation agent to learn to predict animation generation code corresponding to any description text.

The third learning information includes a third learning example, and the third learning example includes a sample function corresponding to sample description text and sample animation generation code.

In some embodiments, referring to FIG. 12, the apparatus further includes:
a text generation module 1110, configured to generate, by a text generation agent, a second description text based on the first description text, content described by the second description text being associated with the content described by the first description text, and the text generation agent being configured to generate a description text.

The function library determining module 1102 is further configured to determine, by the animation guidance agent, a second function library from the plurality of function libraries based on the second description text.

The function determining module 1103 is further configured to determine, by a decision agent corresponding to the second function library, a second function in the second function library based on the second description text.

The code generation module 1104 is further configured to generate, by the code generation agent, animation generation code corresponding to the second description text based on the second function.

The animation generation module 1105 is further configured to execute the animation generation code corresponding to the second description text, to obtain a second animation.

In some embodiments, referring to FIG. 12, the text generation agent belongs to an LLM. The apparatus further includes:
a fourth learning module 1111, configured to input fourth learning information to the text generation agent, the fourth learning information being configured for instructing the text generation agent to learn to predict another description text associated with any description text.

The fourth learning information includes introduction information of the plurality of function libraries and a fourth learning example, the fourth learning example includes a first sample description text and a second sample description text, and content described by the first sample description text is associated with content described by the second sample description text.

The animation generation apparatus provided in the foregoing embodiments is described only using the division of the foregoing functional modules as an example. In practice, the foregoing functions may be allocated to and completed by different functional modules as required. To be specific, an internal structure of a computer device is divided into different functional modules to complete all or some of the functions described above. In addition, the animation generation apparatus provided in the foregoing embodiments belongs to the same conception as the embodiments of the animation generation method. For a specific implementation process thereof, refer to the method embodiment. Details are not described herein again.

According to some embodiments, each module in the apparatus may exist respectively or be combined into one or more units. Certain (or some) unit in the units may be further split into multiple smaller function subunits, thereby implementing the same operations without affecting the technical effects of some embodiments. The modules are divided based on logical functions. In actual applications, a function of one module may be realized by multiple units, or functions of multiple modules may be realized by one unit. In some embodiments, the apparatus may further include other units. In actual applications, these functions may also be realized cooperatively by the other units, and may be realized cooperatively by multiple units.

One or more embodiments further provide a computer device. The computer device includes a processor and a memory, the memory having at least one computer program stored therein, and the at least one computer program being loaded and executed by the processor to implement the operations performed in the animation generation method in the foregoing embodiments.

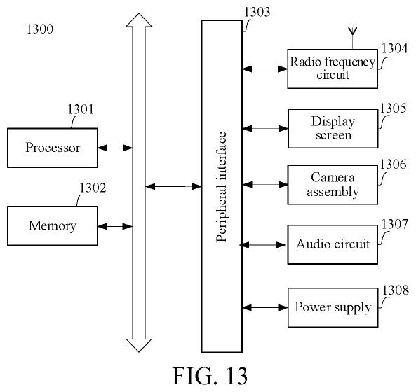

In some embodiments, the computer device is provided as a terminal. FIG. 13 shows a schematic structural diagram of a terminal 1300 according to one or more embodiments.

The terminal 1300 includes a processor 1301 and a memory 1302.

The processor 1301 may include one or more processing cores, for example, a 4-core processor or an 8-core processor. The processor 1301 may be implemented in at least one hardware form of digital signal processing (DSP), a field programmable gate array (FPGA), and a programmable logic array (PLA). The processor 1301 may include a main processor and a coprocessor. The main processor is a processor configured to process data in an awake state, and is also referred to as a central processing unit (CPU). The coprocessor is a low power consumption processor configured to process the data in a standby state. In some embodiments, the processor 1301 may be integrated with a graphics processing unit (GPU). The GPU is configured to render and draw content that needs to be displayed on a display screen. In some embodiments, the processor 1301 may further include an AI processor. The AI processor is configured to perform computing operations related to machine learning.

The memory 1302 may include one or more computer-readable storage media. The computer-readable storage medium may be non-transient. The memory 1302 may further include a high-speed random access memory, and a non-volatile memory, for example, one or more disk storage devices and flash storage devices. In some embodiments, the non-transient computer-readable storage medium in the memory 1302 is configured to store at least one computer program. The at least one computer program is configured to be possessed by the processor 1301 to implement the animation generation method provided in one or more embodiments.

In some embodiments, the terminal 1300 may include a peripheral interface 1303 and at least one peripheral. The processor 1301, the memory 1302, and the peripheral interface 1303 may be connected through a bus or a signal cable. Each peripheral may be connected to the peripheral interface 1303 through a bus, a signal cable, or a circuit board. In some embodiments, the peripheral includes at least one of a radio frequency (RF) circuit 1304, a display screen 1305, a camera assembly 1306, an audio circuit 1307, and a power supply 1308.

The peripheral interface 1303 may be configured to connect the at least one peripheral device related to input/output (I/O) to the processor 1301 and the memory 1302. In some embodiments, the processor 1301, the memory 1302, and the peripheral interface 1303 are integrated on the same chip or circuit board. In some other embodiments, any one or two of the processor 1301, the memory 1302, and the peripheral interface 1303 may be implemented on an independent chip or circuit board. This is not limited in this embodiment.

The RF circuit 1304 is configured to receive and transmit an RF signal, which is also referred to as an electromagnetic signal. The RF circuit 1304 communicates with a communication network and other communication devices through the electromagnetic signal. The RF circuit 1304 converts an electric signal into an electromagnetic signal for transmission, or converts a received electromagnetic signal into an electric signal. In some embodiments, the RF circuit 1304 includes: an antenna system, an RF transceiver, one or more amplifiers, a tuner, an oscillator, a digital signal processor, a codec chip set, a subscriber identity module card, and the like. The RF circuit 1304 may communicate with other devices through at least one wireless communication protocol. The wireless communication protocol includes, but is not limited to, a metropolitan area network, generations of mobile communication networks (2G, 3G, 4G, and 5G), a wireless local area network, and/or a wireless fidelity (WiFi) network. In some embodiments, the RF circuit 1304 may further include a near field communication (NFC)-related circuit. This is not limited herein.

The display screen 1305 is configured to display a user interface (UI). The UI may include graphics, text, icons, videos, and any combination thereof. When the display screen 1305 is a touch display screen, the display screen 1305 further has a capability of acquiring a touch signal on or above a surface of the display screen 1305. The touch signal may be inputted, as a control signal, into the processor 1301 for processing. In this case, the display screen 1305 may be further configured to provide a virtual button and/or a virtual keyboard, which are/is also referred to as a soft button and/or a soft keyboard. In some embodiments, there may be one display screen 1305, disposed on a front panel of the terminal 1300. In some other embodiments, there may be at least two display screens 1305 that are respectively disposed on different surfaces of the terminal 1300 or in a folded design. In some other embodiments, the display screen 1305 may be a flexible display screen, disposed on a curved surface or a folded surface of the terminal 1300. The display screen 1305 may be even configured as a non-rectangular irregular figure, namely, a special-shaped screen. The display screen 1305 may be manufactured by using materials such as a liquid crystal display (LCD) or an organic light-emitting diode (OLED).

The camera assembly 1306 is configured to capture images or videos. In some embodiments, the camera assembly 1306 includes a front camera and a rear camera. The front camera is disposed on the front panel of the terminal 1300, and the rear camera is disposed on the back of the terminal 1300. In some embodiments, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera assembly 1306 may further include a flash. The flash may be a single color temperature flash or a double color temperature flash. The double color temperature flash is a combination of a warm flash and a cold flash, and may be configured to perform light ray compensation at different color temperatures.

The audio circuit 1307 may include a microphone and a speaker. The microphone is configured to acquire sound waves of users and surroundings, and convert the sound waves into electrical signals and input the signals to the processor 1301 for processing, or input the signals to the RF circuit 1304 to implement voice communication. For the purpose of stereo acquisition or noise reduction, a plurality of microphones may be respectively arranged at different parts of the terminal 1300. The microphone may be an array microphone or an omnidirectional acquisition microphone. The speaker is configured to convert the electric signal from the processor 1301 or the RF circuit 1304 into sound waves. The speaker may be a conventional thin-film speaker or a piezoelectric ceramic speaker. When the speaker is a piezoelectric ceramic speaker, the speaker may not only convert an electric signal into sound waves audible to a human being, but also convert an electric signal into sound waves inaudible to the human being for ranging and other purposes. In some embodiments, the audio circuit 1307 may further include a headphone jack.

The power supply 1308 is configured to supply power to assemblies in the terminal 1300. The power supply 1308 may be an alternating current, a direct current, a primary battery, or a rechargeable battery. When the power supply 1308 includes a rechargeable battery, the rechargeable battery may support wired charging or wireless charging. The rechargeable battery may further be configured to support a fast charging technology.

A person skilled in the art may understand that the structure shown in FIG. 13 constitutes no limitation on the terminal 1300. The terminal device may include more or fewer components than those shown in the figure, or some components may be combined, or a different component deployment may be used.

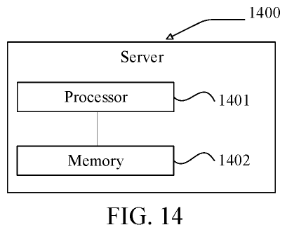

In some embodiments, the computer device is provided as a server. FIG. 14 is a schematic structural diagram of a server according to one or more embodiments. A server 1400 may vary considerably depending on configuration or performance, and may include one or more CPUs 1401 and one or more memories 1402. Each memory 1402 has at least one computer program stored therein. The at least one computer program is loaded and executed by the processor 1401, to implement the methods provided in the foregoing method embodiments. Certainly, the server may further have components such as a wired or wireless network interface, a keyboard, and an I/O interface, to perform input and output. The server may further include another component configured to implement a device function. Details are not described herein.

One or more embodiments further provide a computer-readable storage medium, having at least one computer program stored therein, the at least one computer program being loaded and executed by a processor, to implement the operations performed by the animation generation method in the foregoing embodiments.

One or more embodiments further provide a computer program product, including a computer program, the computer program being loaded and executed by a processor, to implement the operations performed by the animation generation method in the foregoing embodiments.

A person of ordinary skill in the art may understand that all or part of the operations of implementing the foregoing embodiments may be implemented by hardware, or may be implemented by a program instructing related hardware. The program may be stored in a computer-readable storage medium. The foregoing storage medium may be a ROM, a magnetic disk, an optical disc, or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An animation generation method, applied to a computer device, comprising:
obtaining a first description text describing an animation;
determining a first function library from a plurality of function libraries based on the first description text, each of the plurality of function libraries comprising functions for generating animations;
determining a first function in the first function library based on the first description text;
generating animation generation code corresponding to the first description text based on the first function; and
executing the animation generation code corresponding to the first description text to obtain a first animation, content of the first animation conforming to content described by the first description text.

2. The animation generation method according to claim 1, wherein determining the first function library from the plurality of function libraries based on the first description text comprises:
determining, by an animation guidance agent, the first function library from the plurality of function libraries based on the first description text;
wherein generating the animation generation code corresponding to the first description text based on the first function comprises:
generating, by a code generation agent, the animation generation code corresponding to the first description text based on the first function, each function library corresponding to a decision agent; and
wherein determining the first function in the first function library based on the first description text comprises:
determining, by the decision agent corresponding to the first function library, the first function in the first function library based on the first description text.

3. The animation generation method according to claim 1, wherein the plurality of function libraries comprise an action function library, the action function library comprises a plurality of action functions for controlling an action of a virtual object in the animation, and
wherein determining the first function in the first function library based on the first description text comprises:
determining, when the first function library comprises the action function library, a first action function from the plurality of action functions based on the first description text.

4. The animation generation method according to claim 3, wherein the plurality of action functions correspond to action categories, each of the plurality of action functions belongs to one of the action categories, and each action category comprises at least one action function, and
wherein determining the first action function from the plurality of action functions based on the first description text comprises:
determining a target action category from the action categories based on the first description text; and
determining, based on the first description text, the first action function from action functions belonging to the target action category.

5. The animation generation method according to claim 4, wherein determining the target action category from the action categories based on the first description text comprises:
obtaining a mapping relationship between preset description texts and the action categories, and searching the mapping relationship for a similar preset description text having similarity to the first description text greater than a similarity threshold; and
determining the action category corresponding to the similar preset description text as the target action category.

6. The animation generation method according to claim 4, wherein determining the first action function from the plurality of action functions based on the first description text comprises:
determining, by a decision agent corresponding to the action function library, the first action function corresponding to at least one virtual object identifier based on the first description text and the at least one virtual object identifier,
the at least one virtual object identifier indicating the virtual object appearing in the animation, and the first action function corresponding to the at least one virtual object identifier being for controlling an action of the virtual object.

7. The animation generation method according to claim 1, wherein the plurality of function libraries comprise a scene element function library, the scene element function library comprises a plurality of element functions for controlling a scene element in the animation, and
wherein determining the first function in the first function library based on the first description text comprises:
determining, when the first function library comprises the scene element function library, a first element function from the plurality of element functions based on the first description text.

8. The animation generation method according to claim 7, wherein determining the first element function from the plurality of element functions based on the first description text comprises:
determining, by a decision agent corresponding to the scene element function library, the first element function corresponding to at least one virtual object identifier based on the first description text and the at least one virtual object identifier,
the at least one virtual object identifier indicating a virtual object appearing in the animation, and the first element function corresponding to the at least one virtual object identifier being configured for adding the scene element to the virtual object.

9. The animation generation method according to claim 1, wherein before generating the animation generation code corresponding to the first description text based on the first function, the animation generation method further comprises:
determining, by an animation guidance agent, duration information based on the first description text, the duration information indicating duration of a to-be-generated animation; and
wherein generating the animation generation code corresponding to the first description text based on the first function comprises:
generating, by a code generation agent, the animation generation code based on the first function and the duration information, the animation generation code being configured for invoking the first function to generate the animation that conforms to the duration information.

10. The animation generation method according to claim 1, wherein generating the animation generation code corresponding to the first description text based on the first function comprises:
generating, by a code generation agent, the animation generation code based on the first function and at least one virtual object identifier,
the at least one virtual object identifier indicating a virtual object appearing in the animation, and the animation generation code being for invoking the first function to generate the animation comprising the virtual object.

11. The animation generation method according to claim 1, further comprising:
splitting the first description text into a plurality of first segment description texts, the plurality of first segment description texts being configured for describing different animation segments in the same animation, wherein
generating the animation generation code corresponding to the first description text based on the first function comprises:
generating, by a code generation agent, the animation generation code corresponding to the first description text based on first functions corresponding to the plurality of first segment description texts, the animation generation code comprising animation generation code corresponding to each of the plurality of first segment description texts.

12. The animation generation method according to claim 1, wherein determining the first function library from the plurality of function libraries based on the first description text comprises:
determining, by an animation guidance agent, a candidate function library from the plurality of function libraries based on the first description text;
generating, by the animation guidance agent, a detection result based on the first description text and the candidate function library, the detection result indicating whether the candidate function library is accurate, and when the detection result indicates that the candidate function library is incorrect, the detection result further comprising an error reason; and
determining the first function library based on the detection result.

13. The animation generation method according to claim 12, wherein determining the first function library based on the detection result comprises:
determining, when the detection result indicates that the candidate function library is accurate, the candidate function library as the first function library; and
determining, by the animation guidance agent when the detection result indicates that the candidate function library is incorrect, a next candidate function library based on the first description text and the error reason, until the detection result indicates that a currently obtained candidate function library is accurate, and determining the currently obtained candidate function library as the first function library.

14. The animation generation method according to claim 1, wherein determining the first function in the first function library based on the first description text comprises:
determining, by a decision agent, a candidate function in the first function library based on the first description text;
generating, by the decision agent, a detection result based on the first description text and the candidate function, the detection result indicating whether the candidate function is accurate, and when the detection result indicates that the candidate function is incorrect, the detection result further comprising an error reason; and
determining the first function based on the detection result.

15. The animation generation method according to claim 14, wherein determining the first function based on the detection result comprises:
determining, when the detection result indicates that the candidate function is accurate, the candidate function as the first function; and
determining, by the decision agent when the detection result indicates that the candidate function is incorrect, a next candidate function based on the first description text and the error reason, until the detection result indicates that a currently obtained candidate function is accurate, and determining the currently obtained candidate function as the first function.

16. The animation generation method according to claim 1, wherein the first function library is determined by an animation guidance agent, the animation guidance agent belongs to a large language model (LLM), and
wherein before determining the first function library from the plurality of function libraries based on the first description text, the animation generation method further comprises:
inputting first learning information to the animation guidance agent, the first learning information being configured for instructing the animation guidance agent to learn to predict a function library corresponding to any description text,
the first learning information comprising introduction information of the plurality of function libraries and a first learning example, the first learning example comprising a sample description text and a sample function library corresponding to the sample description text, and the sample function library belonging to the plurality of function libraries.

17. The animation generation method according to claim 1, wherein the first function is determined by a decision agent, the decision agent belongs to an LLM, and
wherein before determining the first function in the first function library based on the first description text, the animation generation method further comprises:
inputting second learning information to the decision agent corresponding to the first function library, the second learning information being configured for instructing the decision agent corresponding to the first function library to learn to predict a function corresponding to any description text,
wherein the second learning information comprises introduction information of each function in the first function library and a second learning example, the second learning example comprising a sample description text and a sample function corresponding to the sample description text, and the sample function belonging to the first function library.

18. The animation generation method according to claim 1, wherein the animation generation code is determined by a code generation agent, the code generation agent belongs to an LLM, and
wherein before generating the animation generation code corresponding to the first description text based on the first function, the animation generation method further comprises:
inputting third learning information to the code generation agent, the third learning information being configured for instructing the code generation agent to learn to predict animation generation code corresponding to any description text,
the third learning information comprising a third learning example, and the third learning example comprising a sample function corresponding to sample description text and sample animation generation code.

19. An animation generation apparatus, comprising:
at least one memory configured to store program code; and
at least one processor configured to read the program code and operate as instructed by the program code, the program code comprising:
text obtaining code configured to cause at least one of the at least one processor to obtain a first description text for describing an animation;
function library determining code configured to cause at least one of the at least one processor to determine a first function library from a plurality of function libraries based on the first description text, each of the plurality of function libraries comprising functions for generating animations;
function determining code configured to cause at least one of the at least one processor to determine a first function in the first function library based on the first description text;
code generation code configured to cause at least one of the at least one processor to generate animation generation code corresponding to the first description text based on the first function; and
animation generation code configured to cause at least one of the at least one processor to execute the animation generation code corresponding to the first description text to obtain a first animation, content of the first animation conforming to content described by the first description text.

20. A non-transitory computer-readable storage medium storing computer code which, when executed by at least one processor, causes the at least one processor to at least:
obtain a first description text describing an animation;
determine a first function library from a plurality of function libraries based on the first description text, each of the plurality of function libraries comprising functions for generating animations;
determine a first function in the first function library based on the first description text;
generate animation generation code corresponding to the first description text based on the first function; and
execute the animation generation code corresponding to the first description text to obtain a first animation, content of the first animation conforming to content described by the first description text.
